(19) United States
(12) Patent Application Publication
(10) Pub. No.: US 2018/0249744 A1
(43) Pub. Date: Sep. 6, 2018

(54) SWEETENER COMPOSITIONS AND FOODS, BEVERAGES, AND CONSUMABLE PRODUCTS MADE THEREOF

(71) Applicant: DOUXMATOK LTD, Tel-Aviv (IL)

(72) Inventors: Avraham BANIEL, Jerusalem (IL); Michael ZVIELY, Haifa (IL); Shay ELIYAHU, Tel-Aviv (IL); Noa GELBART, Herzliya (IL); Eran BANIEL, Tel-Aviv (IL); Ronit ROMM, Jerusalem (IL); Nadine MAGAL SANTANA, Kibbutz Magal (IL); Alexander TRACHTENBERG, Ramat-Gan (IL); Yael Miriam HAR-TAL ELIYAHU, Tel-Aviv (IL)

(73) Assignee: DOUXMATOK LTD, Tel-Aviv (IL)

(21) Appl. No.: 15/756,042

(22) PCT Filed: Aug. 26, 2016
(86) PCT No.: PCT/IB2016/001322

§ 371 Date: Feb. 27, 2018

Related U.S. Application Data
(60) Provisional application No. 62/211,596, filed on Aug. 28, 2015.
(60) Provisional application No. 62/236,830, filed on Oct. 2, 2015.
(60) Provisional application No. 62/289,132, filed on Jan. 29, 2016.

(51) Int. Cl. A23L 27/30; A23L 27/00; A23L 5/30

(52) U.S. Cl. CPC A23L 27/33; A23V 2300/48; A23L 5/32; A23V 2002/00; A23V 2200/16; A23V 2250/022; A23V 2250/032; A23V 2250/042; A23V 2250/602; A23V 2250/618; A23V 2250/638; A23V 2250/634; A23V 2250/6402; A23V 2250/6404; A23V 2250/6422; A23V 2300/10; A23V 2300/26; A23L 27/88

(57) ABSTRACT

Provided herein are compositions with enhanced sweetness per weight when compared to the sweetener carbohydrate or sweetener polyol component thereof, and methods for the preparation thereof.

### CROSS-REFERENCE

This application claims the benefit of U.S. Provisional Application No. 62/211,596, filed Aug. 28, 2015; U.S. Provisional Application No. 62/236,830, filed Oct. 2, 2015; and U.S. Provisional Application No. 62/289,132, filed Jan. 29, 2016; each of which is incorporated herein by reference.

### BACKGROUND OF THE INVENTION

Certain carbohydrates and polyols are commonly used as sweeteners. Sucrose, glucose, and other sweet mono-saccharides, di-saccharides, and oligosaccharides are fully metabolized when consumed in food. The sweetness of these natural sweeteners correlates with their calories in a fixed proportion. Excess sugar intake can pose several health problems. Artificial sweeteners have been used to reduce dietary sugar content, but they are not ideal sugar substitutes due to their after taste, absence of energy provided by sugars, and other health concerns. Sweetener polyols can offer a reduced calorie load and varying sweetness as compared to sweetener carbohydrates, but the cost of some sweetener polyols can be high. In such cases, a method to increase the sweetness of sweetener carbohydrates or sweetener polyols or to reduce the amount of sweetener carbohydrates or sweetener polyols while achieving equivalent sweetness is desired. Another promising strategy focuses on allosteric modulation of the sweet taste receptor by sweet taste enhancers. These artificially synthesized molecules do not taste sweet but can significantly modulate the perception of sweetness for sucrose and other sweeteners; however, they can be limited in strength and selectivity and have so far been tested on limited products. The present disclosure provides for the manipulation of the proportion between sweetener amount and calories so that a desired sweetness may correlate with lower calorie values while retaining a similar sensory profile to the sweetener. This effect is achieved through the presentation of the carbohydrate sweetener or polyol sweetener in the form of a composition belonging to a class of compositions described below. The perception of sweetness of a sweetener carbohydrate or sweetener polyol is retained while reducing the caloric value thereof by virtue of it being provided in a composition as described hereinafter.

### SUMMARY OF THE INVENTION

The present disclosure relates to sweetener compositions. More particularly, the present invention relates to carbohydrate sweetener compositions and polyol sweetener compositions having enhanced sweetness as compared to that of the carbohydrate component or polyol component thereof, and to methods for the preparation thereof.

Provided herein is a method of producing a sweetener composition, comprising mixing one or more sweetener carbohydrates and/or sweetener polyols with a carrier compound precursor and a co-reagent or acid to produce a sweetener composition; wherein the sweetener composition comprises one or more sweetener carbohydrates and/or sweetener polyols and about 0.001-4% carrier compound weight/weight relative to a sum of total sweetener carbohydrate and sweetener polyol; the carrier compound is silica; the sweetener composition has enhanced sweetness compared to a control composition; and the control composition consists of the same contents by identity and quantity as the one or more sweetener carbohydrates and/or sweetener polyols.

Provided herein is a method of producing a sweetener composition, comprising mixing one or more sweetener carbohydrates and/or sweetener polyols with a carrier compound precursor and a co-reagent or acid to produce a sweetener composition; wherein the sweetener composition comprises one or more sweetener carbohydrates and/or sweetener polyols and a carrier compound; the sweetener composition has enhanced sweetness compared to a control composition; the one or more sweetener carbohydrates and/or sweetener polyols comprise mannose, allulose, tagatose, xylose, galactose, arabinose, galactofructose, or any combination thereof; and the control composition consists of the same contents by identity and quantity as the one or more sweetener carbohydrates and/or sweetener polyols.

Provided herein is a method of producing a sweetener composition, comprising mixing one or more sweetener carbohydrates and/or sweetener polyols with a carrier compound precursor and a co-reagent or acid to produce a sweetener composition; and homogenizing the sweetener composition; wherein the sweetener composition comprises one or more sweetener carbohydrates and/or sweetener polyols and a carrier compound; the sweetener composition has enhanced sweetness compared to a control composition; and the control composition consists of the same contents by identity and quantity as the one or more sweetener carbohydrates and/or sweetener polyols. Homogenizing the sweetener composition can be performed, for example, using vigorous stirring, high shear homogenization, high pressure homogenization, or a microfluidizer.

Provided herein is a method of producing a sweetener composition, comprising mixing one or more sweetener carbohydrates and/or sweetener polyols with a carrier compound precursor and a co-reagent or acid to produce a sweetener composition; wherein the sweetener composition comprises one or more sweetener carbohydrates and/or sweetener polyols and a carrier compound; the sweetener composition has enhanced sweetness compared to a control composition; the sweetener composition or acid comprises a dairy product, fruit juice, fruit juice concentrate, nectar, or vegetable juice; and the control composition consists of the same contents by identity and quantity as the one or more sweetener carbohydrates and/or sweetener polyols.

A method described herein may further comprise drying the sweetener composition. A method described herein may further comprise dispersing the carrier compound, carrier compound precursor, one or more sweetener carbohydrates and/or sweetener polyols, co-reagent or acid, or sweetener composition (for example, by sonicating and/or homogenizing the sweetener composition). A method described herein may further comprise sonicating the sweetener composition, one or more sweetener carbohydrates and/or sweetener polyols, carrier compound, carrier compound precursor, or co-reagent or acid. A method described herein may further comprise homogenizing the sweetener composition, one or more sweetener carbohydrates and/or sweetener polyols, carrier compound, carrier compound precursor, or co-reagent or acid. A cooling or heating step can optionally take place prior to sonicating and/or homogenizing. Sonicating the sweetener composition may be performed using a bath sonicator or probe sonicator. A method described herein may further comprise passing the sweetener composition through a sieve or sieving tower. A method described herein may further comprise filtering the sweetener composition. A method described herein may further comprise mechanical grinding of the sweetener composition (e.g., by mortar and pestle or mechanical grinder). A method described herein may comprise forming a carrier compound in the presence of one or more sweetener carbohydrates and/or sweetener polyols to form a sweetener composition. The carrier compound may be formed in situ in the presence of one or more sweetener carbohydrates and/or sweetener polyols. Enhanced sweetness for a sweetener composition can be determined using a taste test such as any of the taste tests described herein. In some cases, a sonicator, homogenizer, microfluidizer, and/or colloid mill can be used to disperse a sweetener composition, one or more sweetener carbohydrates and/or sweetener polyols, carrier compound, carrier compound precursor, or co-reagent or acid. For example, when small solid particles are formed within a liquid medium, a dispersion may be obtained. In some cases, dispersed carrier compound (e.g., silica particles) is available to make surface interactions with the sweetener carbohydrates and/or sweetener polyols on the carrier compound's surface and/or within pores of the carrier compound.

In some cases, the sweetener composition includes about 0.001-4%, 0.01-4%, 0.01-2%, or 0.01-0.5% carrier compound weight/weight relative to a sum of total sweetener carbohydrate and sweetener polyol. The one or more sweetener carbohydrates and/or sweetener polyols may be one or more sweetener carbohydrates, such as one sweetener carbohydrate. The one or more sweetener carbohydrates and/or sweetener polyols may be one or more sweetener polyols, such as one sweetener polyol.

Provided herein is a method of producing silica, comprising mixing one or more sweetener carbohydrates and/or sweetener polyols with a carrier compound precursor and a co-reagent or acid to produce silica, wherein the one or more sweetener carbohydrates and/or sweetener polyols comprise mannose, allulose, tagatose, xylose, galactose, arabinose, galactofructose, or any combination thereof.

Provided herein is a method of producing silica, comprising mixing and homogenizing one or more sweetener carbohydrates and/or sweetener polyols with a carrier compound precursor and a co-reagent or acid to produce silica.

Provided herein is a method of producing silica, comprising mixing one or more sweetener carbohydrates and/or sweetener polyols with a carrier compound precursor and a co-reagent or acid to produce silica in the presence of a dairy product, fruit juice, fruit juice concentrate, nectar, or vegetable juice.

A carrier compound precursor may react with a co-reagent or acid to produce silica. A method described herein may further comprise homogenizing and/or sonicating the mixture or the silica.

For any method described herein, the carrier compound precursor may be a silicate. In some cases, for any method described herein, the silicate is sodium silicate, potassium silicate, calcium silicate, aluminum silicate, tetramethylammonium silicate, sodium metasilicate, sodium metasilicate hydrate, calcium metasilicate, or any combination thereof, such as sodium silicate. For any method described herein, the carrier compound precursor may be silicic acid. In some cases, a sweetener composition may comprise a carrier compound precursor (e.g., silicate).

A carrier compound precursor may react with a co-reagent or acid to produce a carrier compound. In some cases, for any method described herein, the co-reagent or acid is an acid, ion exchange resin, ion exchange polymer, or any combination thereof. In some cases, for any method described herein, the acid is a weak acid, strong acid, or any combination thereof. In some cases, for any method described herein, the acid is acetic acid, aconitic acid, adipic acid, alginic acid, ascorbic acid, benzoic acid, caprylic acid, carbonic acid, citric acid, fumaric acid, hydrochloric acid, lactic acid, linoleic acid, malic acid, phosphoric acid, propionic acid, quinic acid, salicylic acid, sorbic acid, stearic acid, succinic acid, sulfuric acid, tannic acid, tartaric acid, vinegar, a dairy product, milk, condensed milk, cream, buttermilk, yogurt, fruit juice, fruit juice concentrate, nectar, vegetable juice, or any combination thereof, such as citric acid, phosphoric acid, or any combination thereof. In some cases, a co-reagent or acid may be dissolved in or mixed with a solvent. In some cases, for any method described herein, the ion exchange resin is Dowex 88(H) or Purolite SST C60H.

In some cases, a method described herein comprises producing about 0.001-4%, 0.01-4%, 0.01-2%, or 0.01-0.5% silica weight/weight relative to a sum of total sweetener carbohydrate and sweetener polyol.

Provided herein is a sweetener composition comprising one or more sweetener carbohydrates and/or sweetener polyols and 0.001-4% carrier compound weight/weight relative to a sum of total sweetener carbohydrate and sweetener polyol; wherein the sweetener composition has enhanced sweetness compared to a control composition; the control composition consists of the same contents by identity and quantity as the one or more sweetener carbohydrates and/or sweetener polyols; and the one or more sweetener carbohydrates and/or sweetener polyols comprise mannose, allulose, tagatose, xylose, galactose, arabinose, galactofructose, or any combination thereof.

Provided herein is a homogenized sweetener composition comprising one or more sweetener carbohydrates and/or sweetener polyols and 0.001-4% carrier compound weight/weight relative to a sum of total sweetener carbohydrate and sweetener polyol; wherein the sweetener composition has enhanced sweetness compared to a control composition; and the control composition consists of the same contents by identity and quantity as the one or more sweetener carbohydrates and/or sweetener polyols.

Provided herein is a sweetener composition comprising one or more sweetener carbohydrates and/or sweetener polyols and 0.001-4% carrier compound weight/weight relative to a sum of total sweetener carbohydrate and sweetener polyol; wherein the sweetener composition has enhanced sweetness compared to a control composition; the sweetener composition comprises a dairy product, fruit juice, fruit juice concentrate, nectar, or vegetable juice; and the control composition consists of the same contents by identity and quantity as the one or more sweetener carbohydrates and/or sweetener polyols.

Provided herein is a sweetener composition made according to a method disclosed herein.

In some cases, the sweetener composition is obtained by the mixing one or more sweetener carbohydrates and/or sweetener polyols with a carrier compound precursor and a co-reagent or acid to obtain the sweetener composition. Enhanced sweetness for a sweetener composition can be determined using a taste test such as any of the taste tests described herein.

In some cases, the sweetener composition may comprise about 0.01-4%, 0.01-2%, or 0.01-0.5% carrier compound weight/weight relative to a sum of total sweetener carbohydrate and sweetener polyol. In some cases, the one or more sweetener carbohydrates and/or sweetener polyols are one or more sweetener carbohydrates, such as one sweetener carbohydrate. In some cases, the one or more sweetener carbohydrates and/or sweetener polyols are one or more sweetener polyols, such as one sweetener polyol.

In some cases, for a method or sweetener composition described herein, the sweetener composition comprises a dairy product, fruit juice, fruit juice concentrate, nectar, or vegetable juice. In some cases, for a method or sweetener composition described herein, the one or more sweetener carbohydrates and/or sweetener polyols comprise mannose, allulose, xylose, galactose, arabinose, galactofructose, or any combination thereof. In some cases, for a method or sweetener composition described herein, the one or more sweetener carbohydrates and/or sweetener polyols are selected from the group consisting of mannose, allulose, tagatose, xylose, galactose, arabinose, galactofructose, and any combination thereof, such as from the group consisting of mannose, allulose, xylose, galactose, arabinose, galactofructose, and any combination thereof. In some cases, for a method or sweetener composition described herein, the one or more sweetener carbohydrates and/or sweetener polyols is tagatose. In some cases, the one or more sweetener carbohydrates are selected from the group consisting of sucrose, glucose, fructose, maltose, lactose, mannose, allulose, tagatose, xylose, galactose, arabinose, galactofructose, high fructose corn syrup, high maltose corn syrup, and any combination thereof. In some cases, for a method or sweetener composition described herein, the one or more sweetener polyols are selected from the group consisting of xylitol, maltitol, erythritol, sorbitol, threitol, arabitol, hydrogenated starch hydrolysates, isomalt, lactitol, mannitol, galactitol (dulcitol), and any combination thereof. In some cases, for a method or sweetener composition described herein, the carrier compound is silica.

In some cases, for a method or sweetener composition described herein, the sweetness is enhanced by at least 10, 20, 30, 40, or 50%. A sweetener composition described herein can reduce the perceived bitterness of a consumable product.

In some cases, the sweetener composition does not comprise an artificial sweetener or a natural sugar substitute.

A sweetener composition described herein can be packaged as an isolated sweetener composition or formulated into a sweetener formulation. A sweetener composition can be formulated as a syrup or as particles. This, and other sweetener formulations of the disclosure, can include water. Alternatively, it can be mixed with one or more artificial sweeteners or high intensity sweeteners to improve flavoring (e.g., reduce bitterness) of such artificial or high intensity sweeteners.

A sweetener formulation can include a food additive. A sweetener formulation can include an artificial sweetener, a natural sugar substitute, or any combination thereof. An artificial sweetener can be one that is selected from the group consisting of: acesulfame potassium, advantame, alitame, aspartame, sodium cyclamate, dulcin, glucin, neohesperidin dihydrochalcone, neotame, P-4000, saccharin, aspartame-acesulfame salt, and sucralose. A natural sugar substitute can be one that is selected from the group consisting of: brazzein, curculin, glycyrrhizin, glycerol, inulin, mogroside, mabinlin, malto-oligosaccharide, mannitol, miraculin, monatin, monellin, osladin, pentadin, stevia, trilobatin, and thaumatin. Any of the sweetener compositions, sweetener formulations, or consumable products described herein may have a reduced perceived bitterness as compared to the same product made using an artificial sweetener and/or a natural sugar substitute instead of a sweetener composition or made without a sweetener composition as described herein.

Provided herein is a composition comprising a consumable product comprising a sweetener composition described herein. In some embodiments, the consumable product is selected from the group consisting of food products, beverage products, pharmaceutical products, and oral hygiene products.

In some cases, a consumable product may contain up to 0.01, 0.05, 0.1, 0.5, 1.0, 1.1, 1.2, 1.3, 1.4, 1.5, 1.6, 1.7, 1.8, 1.9, or 2.0% silica on a weight/weight basis.

In some cases, the consumable product is less bitter than a control product, wherein the control product is identical to the consumable product but lacks the sweetener composition.

Additionally provided herein are methods to make a consumable product. Such methods comprise substituting at least a portion of a sweetener ingredient in a consumable product with a sweetener composition described herein. Additionally or alternatively, a sweetener composition can be added to the process of making the consumable product.

The novel features of the invention are set forth with particularity in the appended claims. A better understanding of the features and advantages of the present invention will be obtained by reference to the following detailed description that sets forth illustrative embodiments, in which the principles of the invention are utilized.

### DETAILED DESCRIPTION OF THE INVENTION

### Introduction

The present disclosure relates to sweetener compositions that can be used alone, formulated into sweetener formulations, or added to or further processed into a processed consumable product. The sweetener compositions herein comprise one or more sweetener carbohydrates and/or sweetener polyols and a carrier compound. The sweetener compositions herein have a sweeter taste than a control composition (e.g., a composition comprising the same contents by identity and quantity as the one or more carbohydrates and/or polyols but without the carrier compound).

### Definitions

As used herein, the term “sweetener carbohydrate” refers to a consumable carbohydrate, which produces a sweet taste when consumed alone. In some cases, a sweetener carbohydrate may be a monosaccharide or disaccharide. A sweetener carbohydrate may be a naturally-occurring carbohydrate. For example, it may be an isolated, purified sweetener. In some cases, a sweetener carbohydrate may be a non-naturally occurring or synthetically-produced carbohydrate. Non-limiting examples of a sweetener carbohydrate include sucrose, glucose, fructose, maltose, lactose, mannose, allulose, tagatose, xylose, galactose, arabinose, galactofructose, high fructose corn syrup, and high maltose corn syrup.

As used herein, the term “sweetener polyol” refers to a consumable polyol, which produces a sweet taste when consumed alone. Non-limiting examples of sweetener polyols include xylitol, maltitol, erythritol, sorbitol, threitol, arabitol, hydrogenated starch hydrolysates, isomalt, lactitol, mannitol, and galactitol (dulcitol). A polyol can be a sugar alcohol. A sugar alcohol can be produced from a corresponding parent carbohydrate by any known method of reduction (via a chemical or biological transformation) of a carboxylic acid or aldehyde to an alcohol. A sweetener polyol can be created synthetically from a parent carbohydrate. In some cases, a sweetener polyol can be covalently attached to a carbohydrate (e.g., a monosaccharide, or di-saccharide). Alternatively or in combination, a sweetener polyol may be bio-derived or obtained from a biological source.

A “sweetener” or “sweetener ingredient” produces a sweet taste when consumed alone. Some non-limiting examples of a sweetener ingredient include a sweetener carbohydrate, sweetener polyol, artificial sweetener, and natural sugar substitute.

As used herein, the term “carrier compound” refers to a food-grade material, which may be coated with a sweetener. A carrier compound, through its large and active surface and structure, may form hydrogen bonds, van der Waals bonds, coordinative bonds, close interactions, and/or electrostatic interactions with a sweetener carbohydrate and/or sweetener polyol. As such, the carbohydrate and/or polyol can maintain its chemical integrity. For instance, the interaction between the carrier compound and the carbohydrate and/or polyol does not need to involve covalent bonds. The carrier compound may associate with the sweetener carbohydrate and/or sweetener polyol to provide characteristics different than a control composition, for instance enhanced sweetness, reduced bitterness, or reduced rate of dissolution. In some cases, a carrier compound may be a solid or a suspension (e.g., monodisperse or polydisperse suspension). A carrier compound may be a solid composition lacking a distinctive taste. A carrier compound may be tasteless, flavorless, or odorless. Digestion of a carrier compound by a human may produce a low amount of usable calories. A carrier compound may be non-caloric. A carrier compound may at least partially dissolve in a solvent (e.g., water). A carrier compound optionally meets test requirements as described in the Food Chemicals Codex (FCC), the European Directive, or Japan's Specifications and Standards for Food Additives. A carrier compound may be formed from a carrier compound precursor. A carrier compound may be formed from a reaction between a carrier compound precursor and a co-reagent or acid. A carrier compound may be formed, precipitated, or dispersed in the presence of one or more sweetener carbohydrates and/or sweetener polyols.

Non-limiting examples of a carrier compound include silica and silicon dioxide. A carrier compound may comprise silica or silicon dioxide (SiO₂). The carrier compound may comprise silica or silicon dioxide. The carrier compound may be silica or silicon dioxide. Non-limiting examples of silica include precipitated silica, porous silica, amorphous silica, colloidal silica, fumed silica, dispersed silica, silica gel, and silica sol. In some cases when the carrier compound is silica, the sweetness of a sweetener composition can have a ratio of silica to sweetener carbohydrate and/or sweetener polyol that gives a maximum sweetness. Increasing the amount of silica relative to sweetener carbohydrate and/or sweetener polyol beyond the maximum point can decrease the sweetness of the sweetener composition. In some cases, wherein the amount of silica is higher than the maximum sweetness amount, a grainy, sandy, or chalky characteristic can enter the taste profile. In some cases, when the amount of silica is less than the maximum sweetness amount, the sweetener composition does not fully benefit from the sweetness enhancement effect of the silica.

A carrier compound can have an average particle size of up to 1, 2, 3, 4, 5, 7, 8, 9, 10, 11, 12, 13, 14, 15, 20, 25, 30, 35, 40, 45, 50, 55, 60, 65, 70, 75, 80, 85, 90, 95, or 100 microns. A carrier compound can have an average particle size of about or at least 1, 2, 3, 4, 5, 7, 8, 9, 10, 11, 12, 13, 14, 15, 20, 25, 30, 35, 40, 45, 50, 55, 60, 65, 70, 75, 80, 85, 90, 95, or 100 microns. In some embodiments, a carrier compound has an average particle size between 1 and 100, 1 and 80, 1 and 50, or 1 and 30 microns.

A carrier compound may have a high specific surface area. In some cases, a carrier compound may have a specific surface area of about or at least 20, 30, 40, 50, 60, 70, 80, 90, 100, 110, 120, 130, 140, 150, 160, 170, 180, 190, 200, 210, 220, 230, 240, 250, 260, 270, 280, 290, 300, 350, 400, 450, 500, 550, 600, 650, 700, 750, 800, 850, 900, 950, or 1000 m²/g. In some cases, a carrier compound may have a specific surface area of up to 20, 30, 40, 50, 60, 70, 80, 90, 100, 110, 120, 130, 140, 150, 160, 170, 180, 190, 200, 210, 220, 230, 240, 250, 260, 270, 280, 290, 300, 350, 400, 450, 500, 550, 600, 650, 700, 750, 800, 850, 900, 950, or 1000 m²/g.

As used herein, the term “carrier compound precursor” refers to a material, which may undergo a chemical reaction to form a carrier compound. The carrier compound precursor may be a silicate. Non-limiting examples of silicate include sodium silicate, potassium silicate, calcium silicate, aluminum silicate, tetramethylammonium silicate, sodium metasilicate, sodium metasilicate hydrate, and calcium metasilicate. The silicate may be sodium silicate. The carrier compound precursor may be silicic acid. A carrier compound precursor may be a combination of two or more distinct carrier compound precursors. In some cases, a carrier compound precursor comprises a carrier compound precursor counterion (e.g., sodium ion in sodium silicate). In some cases, a sweetener composition comprises a carrier compound precursor.

A carrier compound precursor may react with a co-reagent or acid to form a carrier compound. The co-reagent or acid may be food permitted and/or generally recognized as safe. The co-reagent or acid may be one or more acids, bases, ion exchange resins, ion exchange polymers, or any combination thereof. The acid may be a weak acid, strong acid, or any combination thereof. Non-limiting examples of an acid include acetic acid, aconitic acid, adipic acid, alginic acid, ascorbic acid, benzoic acid, caprylic acid, carbonic acid, citric acid, fumaric acid, hydrochloric acid, lactic acid, linoleic acid, malic acid, phosphoric acid, propionic acid, quinic acid, salicylic acid, sorbic acid, stearic acid, succinic acid, sulfuric acid, tannic acid, tartaric acid, vinegar, a dairy product, milk, condensed milk, cream, buttermilk, yogurt, fruit juice, fruit juice concentrate, nectar, and vegetable juice. The ion exchange resin may be a cation exchange resin or anion exchange resin. The ion exchange resin may be a strong acid resin or a weak acid resin. The ion exchange resin may be Dowex 88(H) or Purolite SST C60H. A co-reagent or acid may be a combination of two or more distinct co-reagents or acids. In some cases, two or more co-reagents or acids can be used in series or in parallel. In some cases, the co-reagent or acid is regenerated. In some cases, the co-reagent or acid is not regenerated. In some cases, the co-reagent or acid does not turn over. In some cases, an un-regenerated or non-regenerated co-reagent or acid is a conjugate acid or conjugate base. In some cases, a sweetener composition comprises a co-reagent or acid. In some cases, a co-reagent or acid may be generated from a co-reagent precursor or acid precursor. For example, carbon dioxide may be used to generate an acid such as carbonic acid. A method described herein may further comprise generating a co-reagent or acid from a co-reagent precursor or acid precursor (e.g., carbon dioxide).

In some cases, a co-reagent or acid may be pre-mixed or already in the presence of one or more sweetener carbohydrates and/or sweetener polyols. For example, in some cases, a fruit juice, fruit juice concentrate, nectar, and vegetable juice may have an acidic pH level and contain one or more sweetener carbohydrates and/or sweetener polyols. In some cases, addition of additional co-reagent, acid, sweetener carbohydrates, and/or sweetener polyols may not be necessary. In some cases, mixing one or more sweetener carbohydrates and/or sweetener polyols with a carrier compound precursor and a co-reagent or acid to produce a sweetener composition may refer to mixing a carrier compound precursor with a solution or mixture containing one or more sweetener carbohydrates and/or sweetener polyols and a co-reagent or acid.

As used herein, the term “solvent” refers to a liquid, which may be mixed with or used to dissolve a sweetener composition or one or more components of a sweetener composition. Non-limiting examples of a solvent include water, ethanol, isopropanol, milk, condensed milk, cream, buttermilk, yogurt, fruit juice, fruit juice concentrate, nectar, vegetable juice, dairy product, or a beverage product. The solvent can be potable. Non-limiting examples of water include purified water, distilled water, double distilled water, deionized water, distilled deionized water, drinking water, well water, tap water, spring water, bottled water, carbonated water, mineral water, flavored water, or any combination thereof. A solvent may be a combination of two or more distinct solvents.

As used herein, the term “control composition” refers to a composition, to which a sweetener composition is compared. In some cases, a control composition comprises the one or more sweetener carbohydrates and/or sweetener polyols but not the carrier compound of the sweetener composition to which it is compared. A control composition may be formulated similarly or identically to the sweetener composition. The control composition may comprise the same contents by identity and quantity as the one or more sweetener carbohydrates and/or sweetener polyols of a sweetener composition. In some cases, the one or more sweetener carbohydrates and/or sweetener polyols are in free, unassociated form. The control composition may consist of the same contents by identity and quantity as the one or more sweetener carbohydrates and/or sweetener polyols of a sweetener composition. In other cases, the control composition may consist of the same contents by identity and quantity as the sweetener composition but without the carrier compound. The control composition may consist of the same contents by identity and quantity as the sweetener composition but without carrier compound, unreacted carrier compound precursor, unreacted co-reagent or acid, carrier compound precursor counterion, and/or un-regenerated co-reagent or acid.

As used herein, the term “enhanced sweetness” or “higher perceived sweetness” refers to a stronger or higher sense of sweetness to a human. Sweetener compositions with enhanced sweetness may taste sweeter than the control composition to which they are compared. A smaller amount (by weight or by volume) of a sweetener composition with enhanced sweetness may produce the same sense of sweetness as a larger amount (by weight or by volume) of a control composition that lacks enhanced sweetness. In some formulations, the smaller amount (by weight or by volume) of a sweetener composition with enhanced sweetness that produces the same sense of sweetness as a larger amount (by weight or by volume) of a control composition that lacks enhanced sweetness may have a lower caloric content than the control composition. A sweetener composition with enhanced sweetness may produce a higher perceived sweetness than a control composition with a comparable amount (by weight) of the one or more sweetener carbohydrates and/or sweetener polyols in free, unassociated form. For example, 1.0 grams of a sweetener composition comprising about 0.01 grams of a carrier compound coated with about 0.99 grams of one or more sweetener carbohydrates and/or sweetener polyols may produce a higher perceived sweetness than a control composition that comprises about 0.99 grams of the one or more sweetener carbohydrates and/or sweetener polyols and does not comprise the carrier compound. Examples of tasting methodologies that allow for one to determine if a sweetener composition has enhanced sweetness than a control composition are described in more detail herein.

As used herein, the term “consumable product” refers to a product, which comprises a sweetener composition and other ingredients and may be consumed (e.g., by eating, chewing, drinking, tasting, or swallowing). Consumable products include food products, beverage products, pharmaceutical products, and oral hygiene products, as non-limiting examples. Food products include, but are not limited to, confectionary, chocolate, jam, ice cream, frozen yogurt, soup, whipped cream, baked goods, condiments, sauces, dairy products, and dressings. Beverage products include, but are not limited to, soft drink, flavored water, juice, milk, condensed milk, cream, buttermilk, yogurt, fruit juice, fruit juice concentrate, nectar, vegetable juice, sports drink, energy drink, alcoholic beverage, liqueur, carbonated beverage, caffeinated beverage, coffee, cocoa, tea, dairy products, and dairy drinks. Pharmaceutical products include, but are not limited to, cough syrups, capsules, and tablets. Oral hygiene products include, but are not limited to, tooth paste and mouth wash. Other miscellaneous consumable products include, but are not limited to, chewing gum and spices. Dairy products include, but are not limited to, milk, condensed milk, cream, buttermilk, yogurt, ice cream, frozen yogurt, whipped cream, dairy drinks, creme fraiche, clotted cream, single cream, double cream, whipping cream, sour cream, cultured milk, kefir, powdered milk, evaporated milk, ricotta, infant formula, baked milk, butter, clarified butter, cheese, curds, paneer, whey, cottage cheese, cream cheese, casein, clabber, gelato, frozen custard, and ice milk.

As used herein, the term “about” can be understood as within 10%, 9%, 8%, 7%, 6%, 5%, 4%, 3%, 2%, 1%, 0.5%, 0.1%, 0.05%, or 0.01% of the stated value.

### Sweetener Compositions

A sweetener composition comprises one or more sweetener carbohydrates and/or sweetener polyols and a carrier compound, wherein the sweetener composition has enhanced sweetness compared to a control composition. In some cases, the one or more sweetener carbohydrates and/or sweetener polyols comprise mannose, allulose, tagatose, xylose, galactose, arabinose, galactofructose, or any combination thereof. A sweetener composition may comprise 0.001-4% or 0.01-4% carrier compound weight/weight relative to a sum of total sweetener carbohydrate and sweetener polyol. The control composition may consist of the same contents by identity and quantity as the one or more sweetener carbohydrates and/or sweetener polyols. A sweetener composition may comprise one or more sweetener carbohydrates and a carrier compound. A sweetener composition may comprise one or more polyols and a carrier compound. In some cases, a sweetener composition does not contain a sweetener carbohydrate. In some cases, a sweetener composition does not contain a sweetener polyol.

A sweetener composition can be purified or isolated. A sweetener composition is preferably substantially uniform or homogenous. A sweetener composition can be in the form of a solid (e.g., a powder) or a syrup. In some cases, a sweetener composition is dry and/or dehydrated. A sweetener composition can be in a solvent (e.g., water).

The sweetener composition herein can have a defined ratio of amounts of the carrier compound and the one or more sweetener carbohydrates and/or sweetener polyols. Such a ratio of amounts can be determined by mass, weight, volume, mole, or a combination thereof. In some cases, a ratio of the carrier compound to a sum of total sweetener carbohydrate and sweetener polyol can be about or at least 0.001%, 0.002%, 0.003%, 0.004%, 0.005%, 0.006%, 0.007%, 0.008%, 0.009%, 0.01%, 0.02%, 0.03%, 0.04%, 0.05%, 0.06%, 0.07%, 0.08%, 0.09%, 0.1%, 0.2%, 0.25%, 0.3%, 0.4%, 0.5%, 0.6%, 0.7%, 0.8%, 0.9%, 1.0%, 1.1%, 1.2%, 1.3%, 1.4%, 1.5%, 1.6%, 1.7%, 1.8%, 1.9%, 2.0%, 2.1%, 2.2%, 2.3%, 2.4%, 2.5%, 2.6%, 2.7%, 2.8%, 2.9%, 3.0%, 3.1%, 3.2%, 3.3%, 3.4%, 3.5%, 3.6%, 3.7%, 3.8%, 3.9%, or 4.0%. In some cases, a ratio of the carrier compound to a sum of total sweetener carbohydrate and sweetener polyol can be up to 0.001%, 0.002%, 0.003%, 0.004%, 0.005%, 0.006%, 0.007%, 0.008%, 0.009%, 0.01%, 0.02%, 0.03%, 0.04%, 0.05%, 0.06%, 0.07%, 0.08%, 0.09%, 0.1%, 0.2%, 0.25%, 0.3%, 0.4%, 0.5%, 0.6%, 0.7%, 0.8%, 0.9%, 1.0%, 1.1%, 1.2%, 1.3%, 1.4%, 1.5%, 1.6%, 1.7%, 1.8%, 1.9%, 2.0%, 2.1%, 2.2%, 2.3%, 2.4%, 2.5%, 2.6%, 2.7%, 2.8%, 2.9%, 3.0%, 3.1%, 3.2%, 3.3%, 3.4%, 3.5%, 3.6%, 3.7%, 3.8%, 3.9%, or 4.0%. In some cases, a ratio of the carrier compound to a sum of total sweetener carbohydrate and sweetener polyol can be between about 0.01-4.0%, 0.01-3.0%, 0.01-2.0%, 0.01-1.0%, 0.05-4.0%, 0.05-3.0%, 0.05-2.0%, 0.05-1.0%, 0.1-1.0%, 0.1-0.9%, 0.1-0.8%, 0.1-0.7%, 0.1-0.6%, 0.1-0.5%, 0.1-0.4%, 0.2-0.6%, 0.2-0.5%, 0.2-0.4%, 0.3-0.4%, 1.0-2.0%, 1.0-3.0%, 1.0-4.0%, 2.0-4.0%, 3.0-4.0%, 0.001-4.0%, 0.001-2.0%, 0.001-1.0%, or 0.001-0.01%. In some cases, a ratio of the carrier compound to a sum of total sweetener carbohydrate and sweetener polyol can be about 0.001-4% or about 0.01-4%.

A sweetener composition may have enhanced sweetness compared to a control composition. Preferably, the control composition is the one or more sweetener carbohydrates and/or sweetener polyols but not the carrier compound of the sweetener composition to which it is compared.

The sweetener composition can have a quantified enhanced sweetness. Such enhanced sweetness may be determined by a sensory test. Examples of sensory taste tests are described herein.

In some cases, a sweetener composition can have its sweetness enhanced by about or at least 5%, 10%, 20%, 30%, 40%, 50%, 60%, 70%, 80%, 90%, 100%, 110%, 120%, 130%, 140%, 150%, 160%, 170%, 180%, 190%, 200%, 210%, 220%, 230%, 240%, 250%, 260%, 270%, 280%, 290%, 300%, 350%, 400%, 450%, or 500% relative to a control composition. In some cases, a sweetener composition can have its sweetness enhanced by up to 5%, 10%, 20%, 30%, 40%, 50%, 60%, 70%, 80%, 90%, 100%, 110%, 120%, 130%, 140%, 150%, 160%, 170%, 180%, 190%, 200%, 210%, 220%, 230%, 240%, 250%, 260%, 270%, 280%, 290%, 300%, 350%, 400%, 450%, or 500% relative to a control composition. For example, a sweetener composition can have its sweetness enhanced by 10-500%, 10-300%, 10-200%, 10-100%, 10-80%, 20-70%, or 40-60% relative to a control composition.

The physical properties of a sweetener composition, sweetener formulation, or its individual components can be characterized, for example, by elemental analysis, density, viscosity, microscopy, elemental mapping, refractive index (RI), transmission Fourier transform infrared spectroscopy (FTIR), Inductively Coupled Plasma (ICP), Thermogravimetric Analysis (TGA), dynamic light scattering (DLS), or laser diffraction. For example, the sweetener compositions can be powders with small particle sizes. The particle sizes of a sweetener composition can be measured (e.g., by DLS or laser diffraction). The distribution of particle sizes can be measured by size fractionation of particles using sieves with openings of different sizes. Surface area can be measured, for example, by Brunauer-Emmett-Teller (BET) theory or porosimetry (e.g., mercury porosimetry). Physical properties of a sweetener composition may affect its taste properties. For example, the perceived sweetness of a sweetener composition may be correlated to the distribution of particle sizes.

In some cases, a sweetener composition, for example a syrup sweetener composition, can have an average particle size of up to about 0.1, 0.5, 0.6, 0.7, 0.8, 0.9, 1, 2, 3, 4, 5, 6, 7, 8, 9, or 10 microns. In some cases, a sweetener composition, for example a syrup sweetener composition, can have an average particle size of about or at least about 0.1, 0.5, 0.6, 0.7, 0.8, 0.9, 1, 2, 3, 4, 5, 7, 8, 9, or 10 microns. In some embodiments, a sweetener composition, for example a syrup sweetener composition, has an average particle size between 1 and 10 microns, 1 and 8 microns, 1 and 5 microns, 1 and 4 microns, 1 and 3 microns, 1 and 2 microns, 0.5 and 10 microns, 0.5 and 8 microns, 0.5 and 5 microns, 0.5 and 4 microns, 0.5 and 3 microns, or 0.5 and 2 microns. In some cases, at least about 10, 20, 30, 40, 50, 60, 70, 80, or 90 percent of the particles of a sweetener composition described herein, for example a syrup sweetener composition, are between about 1 micron and about 10 microns in diameter, between about 1 microns and about 8 microns in diameter, between about 1 micron and about 5 microns in diameter, between about 1 microns and about 4 microns in diameter, between about 1 micron and about 3 microns in diameter, between about 1 micron and about 2 microns in diameter, or between about 0.5 micron and about 10 microns in diameter. In some cases, at least 10, 20, 30, 40, 50, 60, 70, 80, or 90 percent of the particles of a sweetener composition described herein, for example a syrup sweetener composition, are less than or equal to 10, 5, 4, 3, or 2 microns in diameter. In some cases, at least about 10, 20, 30, 40, 50, 60, 70, 80, or 90 percent of the particles of a sweetener composition described herein, for example a syrup sweetener composition, are at least about 0.1, 0.5, 1, 2, 3, 4, or 5 microns in diameter.

In some cases, a sweetener composition, for example a dry sweetener composition, can have an average particle size of up to about 50, 60, 70, 80, 90, 100, 200, 300, 400, 500, 600, 700, 800, 900, or 1,000 microns. In some cases, a sweetener composition, for example a dry sweetener composition, can have an average particle size of about or at least about 1, 2, 3, 4, 5, 7, 8, 9, 10, 11, 12, 13, 14, 15, 20, 25, 30, 35, 40, 45, 50, 55, 60, 65, 70, 75, 80, 85, 90, 95, 100, 200, 300, 400, 500, or 600 microns. In some embodiments, a sweetener composition, for example a dry sweetener composition, has an average particle size between 1 and 1,000 microns, 1 and 800 microns, 10 and 800 microns, 1 and 500 microns, 50 and 1,000 microns, 10 and 500 microns, or 50 and 800 microns. In some cases, at least 10, 20, 30, 40, 50, 60, 70, 80, or 90 percent of the particles of a sweetener composition described herein, for example a dry sweetener composition, are between about 1 micron and about 1,000 microns in diameter, between about 25 microns and about 1,000 microns in diameter, or between about 1 micron and about 800 microns in diameter. In some cases, at least 10, 20, 30, 40, 50, 60, 70, 80, or 90 percent of the particles of a sweetener composition described herein, for example a dry sweetener composition, are less than or equal to 1,000, 900, 800, 700, 600, or 500 microns in diameter. In some cases, at least 10, 20, 30, 40, 50, 60, 70, 80, or 90 percent of the particles of a sweetener composition described herein, for example a dry sweetener composition, are at least 1, 2, 3, 4, 5, 25, 100, 200, 300, 400, or 500 microns in diameter.

### Methods of Making Sweetener Compositions

In one instance, a method of producing a sweetener composition comprises: mixing one or more sweetener carbohydrates and/or sweetener polyols with a carrier compound precursor and a co-reagent or acid. In one instance, a method of producing a sweetener composition comprises: mixing one or more sweetener carbohydrates and/or sweetener polyols with a carrier compound precursor and passing the mixture through a co-reagent or acid. The co-reagent or acid then converts the carrier compound precursor to a carrier compound which interacts with the sweetener carbohydrates and/or sweetener polyols to form the sweetener composition. The sweetener carbohydrates and/or sweetener polyols, co-reagent or acid, and carrier compound precursor can be added simultaneously or sequentially in any order. In one example, the sweetener carbohydrates and/or sweetener polyols is first mixed with the carrier compound precursor and then the co-reagent or acid is added. In another example, the sweetener carbohydrates and/or sweetener polyols is first mixed with the co-reagent or acid and then the carrier compound precursor is added. The sweetener composition may comprise one or more sweetener carbohydrates and/or sweetener polyols and a carrier compound. The sweetener composition may have enhanced sweetness compared to a control composition. The one or more sweetener carbohydrates and/or sweetener polyols may comprise mannose, allulose, tagatose, xylose, galactose, arabinose, galactofructose, or any combination thereof. The control composition may consist of the same contents by identity and quantity as the one or more sweetener carbohydrates and/or sweetener polyols.

The mixing can be accomplished by one or more methods including stirring, grinding, compressing, blending, agitating, homogenizing, sonicating, rotational mixing, mortar and pestle, Kenics mixing, drum tumbling, and Turbula mixing.

Once the sweetener composition is generated, the co-reagent or acid and/or un-regenerated co-reagent or acid may be optionally removed. This can be accomplished through various means including filtration to remove an ion exchange resin. However, this is optional and in some cases, the co-reagent or acid and/or un-regenerated co-reagent or acid are not removed.

In some cases, the carrier compound precursor is a silicate and the co-reagent or acid is an acid. In some cases, the carrier compound precursor is a silicate and the co-reagent or acid is an ion exchange resin. In some cases, the carrier compound precursor is a silicate and the co-reagent or acid is a cation exchange resin.

In some cases, the carrier compound precursor is sodium silicate and the co-reagent or acid is an acid. In some cases, the carrier compound precursor is sodium silicate and the co-reagent or acid is an ion exchange resin. In some cases, the carrier compound precursor is sodium silicate and the co-reagent or acid is a cation exchange resin.

In some cases, the carrier compound precursor is silicic acid and the co-reagent or acid is an acid. In some cases, the carrier compound precursor is silicic acid and the co-reagent or acid is a base. In some cases, the carrier compound precursor is silicic acid and the co-reagent or acid is an ion exchange resin.

In some cases, a sweetener composition is produced by mixing or dissolving one or more sweetener carbohydrates and/or sweetener polyols, carrier compound precursor, and/or co-reagent or acid in a solvent.

The above individual components or reagents may be mixed or dissolved in the same or different solvents. A carrier compound precursor, a co-reagent or acid, a solvent, and one or more sweetener carbohydrates and/or sweetener polyols can be mixed together in any order, separately, alternately, simultaneously, or a combination thereof.

Each of the one or more sweetener carbohydrates and/or sweetener polyols, carrier compound precursor, and co-reagent or acid may be mixed with a solvent in any order separately, alternately, simultaneously, or a combination thereof (e.g., mixing one or more sweetener carbohydrates and/or sweetener polyols with a solvent and then adding a carrier compound precursor and a co-reagent or acid; mixing a carrier compound precursor with a solvent and then adding a co-reagent or acid and one or more sweetener carbohydrates and/or sweetener polyols; mixing a co-reagent or acid with a solvent and then adding a carrier compound precursor and one or more sweetener carbohydrates and/or sweetener polyols; mixing one or more sweetener carbohydrates and/or sweetener polyols and a carrier compound precursor with a solvent and then adding a co-reagent or acid; or mixing one or more sweetener carbohydrates and/or sweetener polyols and a co-reagent or acid with a solvent and then adding a carrier compound precursor).

In some cases, mixing or dissolving in a solvent may occur at a temperature of up to 25, 30, 35, 40, 45, 50, 55, 60, 65, 70, 75, 80, 85, 90, 95, or 100° C. The sonication may occur at a temperature of about or at least 25, 30, 35, 40, 45, 50, 55, 60, 65, 70, 75, 80, 85, 90, 95, or 100° C. In some cases, mixing or dissolving in a solvent may occur at room temperature.

For example, the carrier compound silica can be formed in situ by reacting a carrier compound precursor such as sodium silicate with an acid in a solution of sweetener carbohydrate and/or sweetener polyol in water. Silicic acid is produced by the acidification of silicate in aqueous solution. Condensation of silicic acid produces silica. In some cases, the silica precipitates out of solution. In some cases, the silica remains partially or fully dissolved in solution. In some cases, the silica does not precipitate. In some cases, the silica is dispersed in solution. The production of silica in situ in the presence of sweetener forms associations between the silica and sweetener, e.g., through hydrogen bonds, Van Der Waals bonds, coordinative bonds, close interactions, or electrostatic interactions.

During mixing, one or more reaction parameters such as temperature, concentration, stoichiometry, reaction time, order of mixing, mixing speed, mixing time, and pH can be adjusted. Adjusting one or more reaction parameters may affect the molecular structure, porosity, density, and/or particle size of the carrier compound that is formed.

The concentration of one or more sweetener carbohydrates and/or sweetener polyols mixed or dissolved in a solvent can be adjusted. The concentration of one or more sweetener carbohydrates and/or sweetener polyols mixed or dissolved in a solvent may be about or at least 5%, 10%, 15%, 20%, 25%, 30%, 35%, 40%, 45%, 50%, 55%, 60%, 65%, 70%, 75%, 80%, 85%, 90%, 95%, or 100% by weight. The concentration of one or more sweetener carbohydrates and/or sweetener polyols mixed or dissolved in a solvent may be up to 5%, 10%, 15%, 20%, 25%, 30%, 35%, 40%, 45%, 50%, 55%, 60%, 65%, 70%, 75%, 80%, 85%, 90%, 95%, or 100% by weight. In some cases, the concentration of one or more sweetener carbohydrates and/or sweetener polyols mixed or dissolved in a solvent is between about 10-70%, 15-70%, 15-65%, 20-65%, 20-60%, 20-50%, 20-40%, or 20-30%. In some cases, the concentration of one or more sweetener carbohydrates and/or sweetener polyols mixed or dissolved in a solvent is about 20%, about 30%, or about 65%.

The stoichiometry of the co-reagent or acid relative to the carrier compound precursor, carrier compound precursor counterion, or hydroxide ion can be adjusted. The stoichiometry or molar ratio of the co-reagent or acid relative to the carrier compound precursor, carrier compound precursor counter ion, or hydroxide ion may be about or at least 0.1, 0.2, 0.3, 0.4, 0.5, 0.6, 0.7, 0.8, 0.9, 1.0, 1.1, 1.2, 1.3, 1.4, 1.5, 1.6, 1.7, 1.8, 1.9, 2.0, 2.1, 2.2, 2.3, 2.4, 2.5, 2.6, 2.7, 2.8, 2.9, 3.0, 3.1, 3.2, 3.3, 3.4, 3.5, 3.6, 3.7, 3.8, 3.9, 4.0, 4.1, 4.2, 4.3, 4.4, 4.5, 4.6, 4.7, 4.8, 4.9, 5.0, 5.5, 6.0, 6.5, 7.0, 7.5, 8.0, 8.5, 9.0, 9.5, or 10.0. The stoichiometry or molar ratio of the co-reagent or acid relative to the carrier compound precursor, carrier compound precursor counter ion, or hydroxide ion may be up to 0.1, 0.2, 0.3, 0.4, 0.5, 0.6, 0.7, 0.8, 0.9, 1.0, 1.1, 1.2, 1.3, 1.4, 1.5, 1.6, 1.7, 1.8, 1.9, 2.0, 2.1, 2.2, 2.3, 2.4, 2.5, 2.6, 2.7, 2.8, 2.9, 3.0, 3.1, 3.2, 3.3, 3.4, 3.5, 3.6, 3.7, 3.8, 3.9, 4.0, 4.1, 4.2, 4.3, 4.4, 4.5, 4.6, 4.7, 4.8, 4.9, 5.0, 5.5, 6.0, 6.5, 7.0, 7.5, 8.0, 8.5, 9.0, 9.5, or 10.0. The stoichiometry or molar ratio of the co-reagent or acid relative to the carrier compound precursor, carrier compound precursor counterion, or hydroxide ion may be between 0.1-5.0, 0.1-1.0, 1.0-2.0, 2.0-3.0, 3.0-4.0, 4.0-5.0, 0.1-2.0, 1.0-3.0, 2.0-4.0, 3.0-5.0, 0.1-3.0, 1.0-4.0, 2.0-5.0, 0.1-4.0, or 1.0-5.0. The stoichiometry or molar ratio of the co-reagent or acid relative to the carrier compound precursor, carrier compound precursor counterion, or hydroxide ion may be about 1.5.

The reaction temperature can be adjusted. The reaction temperature may be about or at least 15, 20, 25, 30, 35, 40, 45, 50, 55, 60, 65, 70, 75, 80, or 85° C. The reaction temperature may be up to 15, 20, 25, 30, 35, 40, 45, 50, 55, 60, 65, 70, 75, 80, or 85° C. The reaction temperature may be room temperature.

The pH of the reaction mixture can be adjusted. The pH of the reaction mixture may be about or at least 2.0, 2.1, 2.2, 2.3, 2.4, 2.5, 2.6, 2.7, 2.8, 2.9, 3.0, 3.1, 3.2, 3.3, 3.4, 3.5, 3.6, 3.7, 3.8, 3.9, 4.0, 4.1, 4.2, 4.3, 4.4, 4.5, 4.6, 4.7, 4.8, 4.9, 5.0, 5.1, 5.2, 5.3, 5.4, 5.5, 5.6, 5.7, 5.8, 5.9, 6.0, 6.1, 6.2, 6.3, 6.4, 6.5, 6.6, 6.7, 6.8, 6.9, 7.0, 7.1, 7.2, 7.3, 7.4, 7.5, 7.6, 7.7, 7.8, 7.9, 8.0, 8.1, 8.2, 8.3, 8.4, 8.5, 8.6, 8.7, 8.8, 8.9, 9.0, 9.1, 9.2, 9.3, 9.4, 9.5, 9.6, 9.7, 9.8, 9.9, 10.0, 10.1, 10.2, 10.3, 10.4, 10.5, 10.6, 10.7, 10.8, 10.9, 11.0, 11.1, 11.2, 11.3, 11.4, 11.5, 11.6, 11.7, 11.8, 11.9, or 12.0. The pH of the reaction mixture may be up to 2.0, 2.1, 2.2, 2.3, 2.4, 2.5, 2.6, 2.7, 2.8, 2.9, 3.0, 3.1, 3.2, 3.3, 3.4, 3.5, 3.6, 3.7, 3.8, 3.9, 4.0, 4.1, 4.2, 4.3, 4.4, 4.5, 4.6, 4.7, 4.8, 4.9, 5.0, 5.1, 5.2, 5.3, 5.4, 5.5, 5.6, 5.7, 5.8, 5.9, 6.0, 6.1, 6.2, 6.3, 6.4, 6.5, 6.6, 6.7, 6.8, 6.9, 7.0, 7.1, 7.2, 7.3, 7.4, 7.5, 7.6, 7.7, 7.8, 7.9, 8.0, 8.1, 8.2, 8.3, 8.4, 8.5, 8.6, 8.7, 8.8, 8.9, 9.0, 9.1, 9.2, 9.3, 9.4, 9.5, 9.6, 9.7, 9.8, 9.9, 10.0, 10.1, 10.2, 10.3, 10.4, 10.5, 10.6, 10.7, 10.8, 10.9, 11.0, 11.1, 11.2, 11.3, 11.4, 11.5, 11.6, 11.7, 11.8, 11.9, or 12.0. The pH of the reaction mixture may be between about 2.0-12.0, 2.0-11.0, 2.0-10.0, 2.0-9.0, 2.0-8.0, 2.0-7.0, 2.0-6.0, 2.0-5.0, 2.0-4.0, 3.0-10.0, 4.0-10.0, 5.0-10.0, 6.0-10.0, 7.0-10.0, 8.0-10.0, 9.0-10.0, 3.0-9.0, 4.0-9.0, 5.0-9.0, 6.0-9.0, 7.0-9.0, 8.0-9.0, 3.0-8.0, 3.0-7.0, 3.0-6.0, 3.0-5.0, 7.0-8.5, 3.0-4.0, 6.0-8.0, 6.0-7.0, or 7.0-8.0. The pH of the reaction mixture may be about 8.5. The pH of the reaction mixture may be about 7.0.

The reaction of a carrier compound precursor with a co-reagent or acid to form a carrier compound may or may not go to completion. In some cases, the reaction goes to completion. In some cases, the reaction does not go to completion. In some cases, about or at least 10%, 20%, 30%, 40%, 50%, 60%, 70%, 80%, 90%, 91%, 92%, 93%, 94%, 95%, 96%, 97%, 98%, 99%, 99.1%, 99.2%, 99.3%, 99.4%, 99.5%, 99.6%, 99.7%, 99.8%, 99.9%, or 100% of the carrier compound precursor is reacted to form carrier compound. In some cases, up to 10%, 20%, 30%, 40%, 50%, 60%, 70%, 80%, 90%, 91%, 92%, 93%, 94%, 95%, 96%, 97%, 98%, 99%, 99.1%, 99.2%, 99.3%, 99.4%, 99.5%, 99.6%, 99.7%, 99.8%, 99.9%, or 100% of the carrier compound precursor is reacted to form carrier compound. In some cases, about or at least 10%, 20%, 30%, 40%, 50%, 60%, 70%, 80%, 90%, 91%, 92%, 93%, 94%, 95%, 96%, 97%, 98%, 99%, 99.1%, 99.2%, 99.3%, 99.4%, 99.5%, 99.6%, 99.7%, 99.8%, 99.9%, or 100% of the co-reagent or acid is reacted with the carrier compound precursor. In some cases, up to 10%, 20%, 30%, 40%, 50%, 60%, 70%, 80%, 90%, 91%, 92%, 93%, 94%, 95%, 96%, 97%, 98%, 99%, 99.1%, 99.2%, 99.3%, 99.4%, 99.5%, 99.6%, 99.7%, 99.8%, 99.9%, or 100% of the co-reagent or acid is reacted with the carrier compound precursor. In some cases, when the reaction does not go to completion, a sweetener composition may comprise carrier compound precursor, co-reagent, or acid.

### Sweetener Formulations

A sweetener composition may be formulated as a syrup. In some cases, the ratio of total sweetener carbohydrates and/or sweetener polyols to solvent in a sweetener formulation is about or at least 5:95, 10:90, 15:85, 20:80, 25:75, 30:70, 35:65, 40:60, 45:55, 50:50, 55:45, 60:40, 65:35, 70:30, 75:25, 80:20, 85:15, 90:10, 95:5, or 100:0. In some cases, the ratio of total sweetener carbohydrates and/or sweetener polyols to solvent in a sweetener formulation is up to 5:95, 10:90, 15:85, 20:80, 25:75, 30:70, 35:65, 40:60, 45:55, 50:50, 55:45, 60:40, 65:35, 70:30, 75:25, 80:20, 85:15, 90:10, 95:5, or 100:0.

The sweetener compositions herein can be added to or mixed with one or more food additives. Food additives can add volume and/or mass to a sweetener composition. The sweetener compositions herein may be mixed with food additives such that up to 0.001, 0.005, 0.01, 0.05, 0.1, 0.5, 1, 1.5, 2, 2.5, 3, 3.5, 4, 4.5, 5, 6, 7, 8, 9, 10, 15, 20, 25, 30, 35, 40, 45, 50, 55, 60, 65, 70, 75, 80, 85, 90, 91, 92, 93, 94, 95, 96, 97, 98, or 99 weight % of the sweetener formulation is food additives. The sweetener compositions herein may be mixed with food additives such that about or at least 0.001, 0.005, 0.01, 0.05, 0.1, 0.5, 1, 1.5, 2, 2.5, 3, 3.5, 4, 4.5, 5, 6, 7, 8, 9, 10, 15, 20, 25, 30, 35, 40, 45, 50, 55, 60, 65, 70, 75, 80, 85, 90, 91, 92, 93, 94, 95, 96, 97, 98, or 99 weight % of the sweetener formulation is food additives. Some non-limiting examples of a food additive include food coloring, natural flavoring, artificial flavoring, batch marker, food stabilizer, food acid, filler, anticaking agent, antioxidant, bulking agent, color retention agent, emulsifier, humectant, thickener, pharmaceutical excipient, solid diluent, acid salt, alkali salt, organic salt, inorganic salt, nutrient (e.g., macronutrient, micronutrient, essential nutrient, non-essential nutrient, dietary fiber, amino acid, vitamin, dietary mineral), sweetener, artificial sweetener, natural sugar substitute, and preservative, for example. Some non-limiting examples of food additives are silica, silicon dioxide, cellulose, microcrystalline cellulose, powdered cellulose, starch, modified food starch, amylum, calcium carbonate, maltodextrin, hemicellulose, cyclodextrins, hydroxyalkyl cyclodextrins (e.g., hydroxypropyl and methyl cyclodextrins), inulin, pectin, chitin, chitosan, carrageenans, metal oxide, zinc oxide, aluminum oxide, titanium oxide, titanium dioxide, magnesium oxide, magnesium hydroxide, calcium oxide, agar, natural gums (e.g., gum arabic, gellan gum, guar gum, locust bean gum, and xanthan gum), and magnesium stearate. Some non-limiting examples of an artificial sweetener are acesulfame potassium, advantame, alitame, aspartame, sodium cyclamate, dulcin, glucin, neohesperidin dihydrochalcone, neotame, P-4000, saccharin, aspartame-acesulfame salt, and sucralose. Some non-limiting examples of natural sugar substitutes are brazzein, curculin, glycyrrhizin, glycerol, inulin, mogroside, mabinlin, malto-oligosaccharide, mannitol, miraculin, monatin, monellin, osladin, pentadin, stevia (including partly stevia components), trilobatin and thaumatin. In some cases, a food additive may be a byproduct of the method of making a sweetener composition. For instance, a food additive may be a carrier compound precursor, a carrier compound precursor counter ion, a co-reagent or acid, and/or an unregenerated co-reagent or acid. In some cases, a food additive may be a conjugate acid salt of a co-reagent or base or a conjugate base salt of a co-reagent or acid. In some cases, a compound can function as one or more of a carrier compound, a food additive, and a sweetener carbohydrate or sweetener polyol. A food additive may be a combination of two or more distinct food additives. In some cases, a sweetener composition, sweetener formulation, and/or silica does not comprise DNA, protein, lignin, and/or magnetic particles. In some cases when a dairy product, fruit juice, fruit juice concentrate, nectar, or vegetable juice is used, a sweetener composition, sweetener formulation, and/or silica may comprise DNA, protein, and/or lignin. In some cases, a sweetener composition, sweetener formulation, and/or silica does not comprise an artificial sweetener, such as sucralose. In some cases, a sweetener composition, sweetener formulation, and/or silica does not comprise a natural sugar substitute. In some cases, a sweetener composition, sweetener formulation, and/or silica does not comprise a food additive.

About or at least 5, 10, 15, 20, 25, 30, 35, 40, 45, 50, 55, 60, 65, 70, 75, 80, 85, 90, 95, 96, 97, 98, 99, 99.5, 99.9, or 100% of the sweetener formulation by weight may be one, two, three, four, or five components selected from the group consisting of one or more sweetener carbohydrates, one or more sweetener polyols, one or more carrier compounds, one or more solvents, and one or more food additives. Up to 5, 10, 15, 20, 25, 30, 35, 40, 45, 50, 55, 60, 65, 70, 75, 80, 85, 90, 95, 96, 97, 98, 99, 99.5, 99.9, or 100% of the sweetener formulation by weight may be one, two, three, four, or five components selected from the group consisting of one or more sweetener carbohydrates, one or more sweetener polyols, one or more carrier compounds, one or more solvents, and one or more food additives. A component may include one or more examples of that component (e.g., a sweetener formulation consisting of sucrose, glucose, fructose, silica, and water can be considered to contain three components: sweetener carbohydrate, carrier compound, and solvent).

Methods of Making and/or Formulating Sweetener Compositions and/or Sweetener Formulations

A method of making and/or formulating a sweetener composition, sweetener formulation, and/or silica may comprise drying and/or concentrating. In some cases, drying forms a dry, dehydrated, concentrated, and/or solid sweetener composition, sweetener formulation, and/or silica. Some non-limiting examples of drying methods include thermal drying, evaporation (e.g., by means of vacuum or air), distillation, boiling, heating in an oven, vacuum drying, spray drying, freeze drying, lyophilization, or any combination thereof. The mechanism of drying can affect the hydration and molecular structure of the sweetener composition, sweetener formulation, and/or silica thus giving rise to sweetener compositions and/or formulations with different physical properties. The sweetener composition, sweetener formulation, and/or silica can be dried until the sweetener composition, sweetener formulation, and/or silica comprises up to 0.001, 0.005, 0.01, 0.05, 0.1, 0.2, 0.3, 0.4, 0.5, 0.6, 0.7, 0.8, 0.9, 1.0, 1.5, 2, 2.5, 3, 3.5, 4, 4.5, 5, 6, 7, 8, 9, 10, 11, 12, 13, 14, 15, 16, 17, 18, 19, 20, 25, 30, 35, 40, 45, 50, 55, 60, 65, 70, 75, or 80% solvent (e.g., water) by weight. The sweetener composition, sweetener formulation, and/or silica can be dried until the sweetener composition, sweetener formulation, and/or silica comprises about or at least 0.001, 0.005, 0.01, 0.05, 0.1, 0.2, 0.3, 0.4, 0.5, 0.6, 0.7, 0.8, 0.9, 1.0, 1.5, 2, 2.5, 3, 3.5, 4, 4.5, 5, 6, 7, 8, 9, 10, 11, 12, 13, 14, 15, 16, 17, 18, 19, 20, 25, 30, 35, 40, 45, 50, 55, 60, 65, 70, 75, or 80% solvent (e.g., water) by weight. For example, a sweetener composition formulated as a syrup can be dried via any standard drying method (e.g., 12-80 hours in an oven at 60° C., using industrial air blowers, etc.) to remove a solvent to form a dry solid sweetener composition, sweetener formulation, and/or silica. In another example, a sweetener composition formulated as a syrup can be concentrated (e.g., from a syrup with 80% water to a syrup with 35% water).

A method of making and/or formulating a sweetener composition, sweetener formulation, and/or silica may comprise diluting and/or hydrating. In some cases, the diluting may comprise addition of a solvent. The sweetener composition, sweetener formulation, and/or silica can be diluted until the sweetener composition, sweetener formulation, and/or silica comprises up to 0.01, 0.05, 0.1, 0.2, 0.3, 0.4, 0.5, 0.6, 0.7, 0.8, 0.9, 1, 1.5, 2, 2.5, 3, 3.5, 4, 4.5, 5, 6, 7, 8, 9, 10, 11, 12, 13, 14, 15, 16, 17, 18, 19, 20, 25, 30, 35, 40, 45, 50, 55, 60, 65, 70, 75, 80, 85, 90, 95, 96, 97, 98, 99, 99.5, or 99.9% water by weight. The sweetener composition, sweetener formulation, and/or silica can be diluted until the sweetener composition, sweetener formulation, and/or silica comprises about or at least 0.01, 0.05, 0.1, 0.2, 0.3, 0.4, 0.5, 0.6, 0.7, 0.8, 0.9, 1, 1.5, 2, 2.5, 3, 3.5, 4, 4.5, 5, 6, 7, 8, 9, 10, 11, 12, 13, 14, 15, 16, 17, 18, 19, 20, 25, 30, 35, 40, 45, 50, 55, 60, 65, 70, 75, 80, 85, 90, 95, 96, 97, 98, 99, 99.5, or 99.9% water by weight. For example, a sweetener composition formulated as a syrup can be diluted (e.g., from a syrup with 35% water to a syrup with 80% water). In another example, a dry sweetener composition can be hydrated (e.g., from a dry solid to a syrup with 80% water).

A method of making and/or formulating a sweetener composition, sweetener formulation, and/or silica may comprise mechanical mixing or grinding. A sweetener composition, sweetener formulation, silica, individual component (e.g., sweetener carbohydrate, sweetener polyol), individual reagent (e.g., carrier compound precursor, co-reagent or acid), intermediate, and/or reaction mixture can be mixed or ground by one or more mechanical methods. Non-limiting examples of mechanical methods include stirring, grinding, compressing, blending, agitating, homogenizing, sonicating, rotational mixing, mortar and pestle, Kenics mixing, drum tumbling, and Turbula mixing. In some cases, two or more forms of mechanical methods can be used in series or in parallel. For example, a sweetener composition, sweetener formulation, and/or silica can be ground mechanically in a grinder and subsequently further ground mechanically via mortar and pestle.

The conditions of the mechanical coating, mixing, or grinding (e.g., temperature, time duration, speed, timing, rate, force, pressure, etc.) can affect the sweetness of the resulting composition and/or formulation. These conditions may be selected to give the largest enhancement of sweetness to the resulting composition and/or formulation. Mixing or grinding may be carried out for about or at least 0.1, 0.2, 0.3, 0.4, 0.5, 1.0, 2.0, 3.0, 4.0, 5.0, 6.0, 7.0, 8.0, 9.0, 10.0, 12.0, 14.0, 16.0, 18.0, or 20.0 min. Mixing or grinding may be carried out for up to 0.1, 0.2, 0.3, 0.4, 0.5, 1.0, 2.0, 3.0, 4.0, 5.0, 6.0, 7.0, 8.0, 9.0, 10.0, 12.0, 14.0, 16.0, 18.0, or 20.0 min. In some cases when two or more forms of mechanical methods are used in series or in parallel, the timing and conditions of each form can be selected independently.

A method of making and/or formulating a sweetener composition, sweetener formulation, and/or silica may comprise sonicating. A sweetener composition, sweetener formulation, silica, individual component (e.g., sweetener carbohydrate, sweetener polyol), individual reagent (e.g., carrier compound precursor, co-reagent or acid), intermediate, and/or reaction mixture can be sonicated and optionally cooled prior to sonication (e.g., to room temperature or to the temperature that sonication occurs at). The sonication can be for up to 1, 2, 3, 4, 5, 6, 7, 8, 9, 10, 12, 14, 16, 20, 24, 30, 40, 50, or 60 min. The sonication can be for about or at least 1, 2, 3, 4, 5, 6, 7, 8, 9, 10, 12, 14, 16, 20, 24, 30, 40, 50, or 60 min. The sonication may occur with heating. The sonication may occur at a temperature of up to 25, 30, 35, 40, 45, 50, 55, 60, 65, 70, 75, 80, 85, 90, 95, or 100° C. The sonication may occur at a temperature of about or at least 25, 30, 35, 40, 45, 50, 55, 60, 65, 70, 75, 80, 85, 90, 95, or 100° C. The sonication may occur during grinding or mixing. The sweetener composition, sweetener formulation, and/or silica may be sonicated. In some cases, the sweetener composition, sweetener formulation, and/or silica is not sonicated. Sonication may be mild. Sonication may be performed in a bath sonicator. Sonication may be performed using a probe sonicator. In some cases, sonication is not performed using a probe sonicator. In some cases, sonication does not affect the particle size of the sweetener composition, sweetener formulation, carrier compound, and/or silica. In some cases, sonication may affect the particle size of the sweetener composition, carrier compound, silica, and/or sweetener formulation.

A method of making and/or formulating a sweetener composition, sweetener formulation, and/or silica may comprise homogenizing. A sweetener composition, sweetener formulation, silica, individual component (e.g., sweetener carbohydrate, sweetener polyol), intermediate, and/or mixture can be homogenized and optionally cooled prior to homogenization (e.g., to room temperature or to the temperature that homogenization occurs at). The homogenization can be for up to 1, 2, 3, 4, 5, 6, 7, 8, 9, 10, 12, 14, 16, 20, 24, 30, 40, 50, or 60 min. The homogenization can be for about or at least 1, 2, 3, 4, 5, 6, 7, 8, 9, 10, 12, 14, 16, 20, 24, 30, 40, 50, or 60 min. The homogenization may occur with heating. The homogenization may occur at a temperature of up to 25, 30, 35, 40, 45, 50, 55, 60, 65, 70, 75, 80, 85, 90, 95, or 100° C. The homogenization may occur at a temperature of about or at least 25, 30, 35, 40, 45, 50, 55, 60, 65, 70, 75, 80, 85, 90, 95, or 100° C. The homogenization may occur at room temperature. The homogenization may occur under pressure (e.g., up to 2,000 bars). The homogenization may occur during grinding or mixing. The sweetener composition, sweetener formulation, and/or silica may be homogenized. In some cases, the sweetener composition, sweetener formulation, and/or silica is not homogenized. In some cases, homogenization may be performed in a homogenizer, rotor-stator homogenizer, high-shear mixer (e.g., batch high-shear mixer, inline high-shear mixer, inline powder induction, high-shear granulator, ultra-high-shear inline mixer, high speed disperser, solids injection, high shear rotor-stator mixer, in-tank mixer), high shear homogenizer, high pressure homogenizer, or microfluidizer. In some cases, homogenization does not affect the particle size of the sweetener composition, sweetener formulation, carrier compound, and/or silica. In some cases, homogenization may affect the particle size of the sweetener composition, carrier compound, silica, and/or sweetener formulation.

A sweetener composition, sweetener formulation, silica, individual component (e.g., sweetener carbohydrate, sweetener polyol), individual reagent (e.g., carrier compound precursor, co-reagent or acid), intermediate, and/or reaction mixture can be precipitated from liquid medium by using an antisolvent or volatile liquid. For example, a sweetener composition, sweetener formulation, silica, individual component (e.g., sweetener carbohydrate, sweetener polyol), individual reagent (e.g., carrier compound precursor, co-reagent or acid), intermediate, and/or reaction mixture can be precipitated from aqueous solution by using an antisolvent or volatile liquid to form a precipitate that can be filtered and/or dried to obtain a solid. In some embodiments, the antisolvent or volatile liquid can be ethanol. In some embodiments, the antisolvent or volatile liquid is a solvent in which a sweetener composition, sweetener formulation, silica, individual component (e.g., sweetener carbohydrate, sweetener polyol), individual reagent (e.g., carrier compound precursor, co-reagent or acid), intermediate, and/or reaction mixture is sparingly soluble, insoluble, or less soluble than then liquid medium.

A method of making and/or formulating a sweetener composition, sweetener formulation, and/or silica may comprise filtering and/or sieving. A sweetener composition, sweetener formulation, silica, individual component (e.g., sweetener carbohydrate, sweetener polyol), individual reagent (e.g., carrier compound precursor, co-reagent or acid), intermediate, and/or reaction mixture can be passed through a sieve or sieving tower to remove particles of particular sizes, of at least a minimum size, of at most a maximum size, or of at least a minimum size and at most a maximum size from the sweetener composition, sweetener formulation, and/or silica. The sieve can have a mesh with openings up to 18, 20, 25, 30, 40, 50, 60, 70, 80, 90, 100, 110, 120, 130, 140, 150, 160, 170, 180, 190, or 200 mesh. The sieve can have a mesh with openings of about or at least 18, 20, 25, 30, 40, 50, 60, 70, 80, 90, 100, 110, 120, 130, 140, 150, 160, 170, 180, 190, or 200 mesh. The sieve can have a mesh with openings of about 40 to about 100 mesh or openings of about 60 to about 70 mesh.

A method of making and/or formulating a sweetener composition, sweetener formulation, and/or silica may comprise isolating or purifying. In some cases, the method comprises removing a portion of the unreacted carrier compound precursor. In some cases, the method comprises removing a portion of the carrier compound precursor counterion. In some cases, the method comprises removing a portion of the co-reagent or acid. In some cases, the method comprises removing a portion of the unregenerated co-reagent or acid.

### Applications of Sweetener Compositions

A sweetener composition provided herein may be used as a sweetener for a consumable product. A consumable product may comprise a composition provided herein. Some non-limiting examples of a consumable product include food products, beverage products, pharmaceutical products, and oral hygiene products.

The consumable product may contain silica. In some cases, the consumable product may contain up to 0.0001, 0.0005, 0.001, 0.005, 0.01, 0.05, 0.1, 0.2, 0.3, 0.4, 0.5, 0.6, 0.7, 0.8, 0.9, 1.0, 1.1, 1.2, 1.3, 1.4, 1.5, 1.6, 1.7, 1.8, 1.9, or 2.0% silica weight/weight. In some cases, the consumable product may contain about or at least 0.0001, 0.0005, 0.001, 0.005, 0.01, 0.05, 0.1, 0.2, 0.3, 0.4, 0.5, 0.6, 0.7, 0.8, 0.9, 1.0, 1.1, 1.2, 1.3, 1.4, 1.5, 1.6, 1.7, 1.8, 1.9, or 2.0% silica weight/weight.

The consumable product may have an acidic pH. In some cases, the consumable product may have a pH of about or at least 2.0, 2.1, 2.2, 2.3, 2.4, 2.5, 2.6, 2.7, 2.8, 2.9, 3.0, 3.1, 3.2, 3.3, 3.4, 3.5, 3.6, 3.7, 3.8, 3.9, 4.0, 4.1, 4.2, 4.3, 4.4, 4.5, 4.6, 4.7, 4.8, 4.9, 5.0, 5.1, 5.2, 5.3, 5.4, 5.5, 5.6, 5.7, 5.8, 5.9, 6.0, 6.1, 6.2, 6.3, 6.4, 6.5, 6.6, 6.7, 6.8, or 6.9. In some cases, the consumable product may have a pH of up to 2.0, 2.1, 2.2, 2.3, 2.4, 2.5, 2.6, 2.7, 2.8, 2.9, 3.0, 3.1, 3.2, 3.3, 3.4, 3.5, 3.6, 3.7, 3.8, 3.9, 4.0, 4.1, 4.2, 4.3, 4.4, 4.5, 4.6, 4.7, 4.8, 4.9, 5.0, 5.1, 5.2, 5.3, 5.4, 5.5, 5.6, 5.7, 5.8, 5.9, 6.0, 6.1, 6.2, 6.3, 6.4, 6.5, 6.6, 6.7, 6.8, or 6.9.

The consumable product may have a neutral pH. In some cases, the consumable product may have a pH of about or at least 7.0. In some cases, the consumable product may have a pH of up to 7.0.

The consumable product may have a basic pH. In some cases, the consumable product may have a pH of about or at least 7.1, 7.2, 7.3, 7.4, 7.5, 7.6, 7.7, 7.8, 7.9, 8.0, 8.1, 8.2, 8.3, 8.4, 8.5, 8.6, 8.7, 8.8, 8.9, 10.0, 10.1, 10.2, 10.3, 10.4, 10.5, 10.6, 10.7, 10.8, 10.9, 11.0, 11.1, 11.2, 11.3, 11.4, 11.5, 11.6, 11.7, 11.8, 11.9, 12.0, 12.1, 12.2, 12.3, 12.4, 12.5, 12.6, 12.7, 12.8, or 12.9. In some cases, the consumable product may have a pH of up to 7.1, 7.2, 7.3, 7.4, 7.5, 7.6, 7.7, 7.8, 7.9, 8.0, 8.1, 8.2, 8.3, 8.4, 8.5, 8.6, 8.7, 8.8, 8.9, 10.0, 10.1, 10.2, 10.3, 10.4, 10.5, 10.6, 10.7, 10.8, 10.9, 11.0, 11.1, 11.2, 11.3, 11.4, 11.5, 11.6, 11.7, 11.8, 11.9, 12.0, 12.1, 12.2, 12.3, 12.4, 12.5, 12.6, 12.7, 12.8, or 12.9.

A method of producing a consumable product may comprise adding a sweetener composition, sweetener formulation, and/or silica to the consumable product or substituting a portion of one or more sweetener ingredients in the consumable product with a sweetener composition, sweetener formulation, and/or silica. The consumable product may have enhanced sweetness, lower caloric value, reduced bitterness, or any combination thereof. The sweetener composition, sweetener formulation, and/or silica may reduce the perceived bitterness of a consumable product. The sweetener compositions and/or formulations described herein can function as bitterness reducers and, in some instances, as bitterness masking agents. For example, adding a sweetener composition, sweetener formulation, and/or silica described herein to a consumable product can reduce or mask a bitter taste. A sweetener composition, sweetener formulation, and/or silica as described herein can reduce the bitterness of a medicine or pharmaceutical. For example, a method of reducing bitterness in a medicine or pharmaceutical can comprise adding a sweetener composition, sweetener formulation, and/or silica described herein to the medicine or pharmaceutical. Reducing the bitterness of a medicine can have the beneficial effect of increasing patient compliance and desire to take a medicine, particularly with pediatric patients. A consumable product may comprise one or more modifying components that allow for incorporation of the sweetener composition, sweetener formulation, and/or silica.

A sweetener composition, sweetener formulation, and/or silica described herein can be added to or substituted into (e.g., by replacing a portion of one or more sweetener ingredients in the consumable product) a consumable product to produce at least 1, 2, 3, 4, 5, 6, 7, or 8; up to 1, 2, 3, 4, 5, 6, 7, or 8; or about 1, 2, 3, 4, 5, 6, 7, or 8 of the characteristics selected from the group consisting of increased sweetness, reduction of sweetener used while maintaining sweetness sensation, increased creamy aftertaste, decreased bitter aftertaste, decreased mouth drying aftereffect, decreased metallic aftertaste, decreased liquorice aftertaste, and reduced caloric value of the consumable product. The characteristic of the consumable product comprising the sweetener composition, sweetener formulation, and/or silica can be compared to a control product that does not have the sweetener composition, sweetener formulation, and/or silica added to it or substituted into it. For example, a consumable product with an added or substituted sweetener composition, sweetener formulation, and/or silica can have one or more of the characteristics enhanced by about or at least 5%, 10%, 20%, 30%, 40%, 50%, 60%, 70%, 80%, 90%, 100%, 110%, 120%, 130%, 140%, 150%, 160%, 170%, 180%, 190%, 200%, 210%, 220%, 230%, 240%, 250%, 260%, 270%, 280%, 290%, or 300% relative to a control product. A consumable product with an added or substituted sweetener composition, sweetener formulation, and/or silica can have one or more of the characteristics enhanced by up to 5%, 10%, 20%, 30%, 40%, 50%, 60%, 70%, 80%, 90%, 100%, 110%, 120%, 130%, 140%, 150%, 160%, 170%, 180%, 190%, 200%, 210%, 220%, 230%, 240%, 250%, 260%, 270%, 280%, 290%, or 300% relative to a control product. For example, the sweetness can be enhanced by 10-500%, 10-300%, 10-200%, 10-100%, 10-80%, 20-70%, or 40-60% relative to a control product.

### Sensory Testing

Enhanced or equivalent sweetness can be determined by a sensory test. The sensory test may be a taste test, a blind test, or a combination thereof. One non-limiting example of a taste test method to measure enhanced sweetness is to taste a set amount of a control composition, and then taste varying amounts of the sweetener composition to find the amount of sweetener composition that corresponds to the sweetness of the control composition. The enhanced sweetness can be calculated by the following formula: [amount of control composition−amount of sweetener composition required for equal sweetness]/[amount of control composition]. For example, varying amounts of a sweetener composition described herein (e.g., 8, 7, 6, 5, 4, 3, 2 and 1 mg of a composition comprising 65% sucrose and 0.4% silica) are tasted to find an equal sweetness to a control composition (e.g., 8 mg of 65% sucrose solution). In this case, if the test shows that 4 mg of the sweetener composition has an equivalent sweetness to 8 mg of the control composition, then the enhanced sweetness is calculated as (8-4)/8=50%.

A sensory test can use one or more various protocols. For example, a sensory test can be the “triangle method”, follow ISO requirements, or a combination thereof. The taste test can be the average of multiple trials. For example, each taste tester can consume multiple sweetener compositions or foods, beverages, or consumable products comprising a sweetener composition and sequence them by relative sweetness. A taste test can comprise tasting a standard and determining whether a tested composition is more or less sweet than the standard.

A taste test may be a screening test, a professional taste test, or a market research test. A screening test may be performed by at least 1, 2, 3, 4, 5, 6, 7, 8, or 9 taste testers. A professional taste test may be performed by at least 10, 15, 20, 25, or 30 taste testers. A market research test may be performed by at least 31, 40, 50, 60, 70, 80, 90, 100, 150, 200, 300, 400, or 500 taste testers. In some cases, a taste tester can be a person with average taste perception, a professional taste tester, a person who has passed a tasting exam by correctly identifying foods or food components, or a person who can identify the relative amounts of a taste or flavor (e.g., correctly sequence varying amounts of sugar in water).

### Examples

### Example 1: Method of Producing a Sweetener Composition

A) One or more sweetener carbohydrates and/or sweetener polyols are dissolved in a solvent (e.g., water, such as deionized water). Alternatively, sweetener carbohydrates and/or sweetener polyols found naturally in foods may be used. As a non-limiting example, sugars from dairy products, milk, condensed milk, cream, buttermilk, yogurt, fruits and/or vegetables (e.g., fruit juice, fruit juice concentrate, nectar, vegetable juice) may be used to produce a sweetener composition. In some cases, no further addition of solvent is needed, other than the liquid naturally found in such juices or concentrates.

A juice, juice concentrate, or nectar can be made from, but is not limited to, acai berry, aloe, apple, apricot, avocado, banana, beetroot, berry, blackberry, black currant, blood orange, blueberry, boysenberry, calamansi, cantaloupe, carrot, celery, cherry, citrus, concord grape, corn, cranberry, cucumber, dandelion, date, dragonfruit, durian, elderberry, fig, ginger, goji, grape, grapefruit, green coconut, guava, honeydew, jackfruit, kaffir lime, kiwifruit, lemon, lettuce, lime, lingonberry, lychee, mango, mangosteen, melon, orange, papaya, parsley, passionfruit, peach, pear, persimmon, pineapple, plum, pomegranate, pomelo, prune, quince, raspberry, red currant, rhubarb, soursop, spinach, strawberry, sugarcane, tamarind, tomato, turnip, watercress, watermelon, wheatgrass, white currant, winter melon, and any combination thereof.

B) A carrier compound precursor and a co-reagent or acid are added. The sweetener carbohydrates and/or sweetener polyols, co-reagent or acid, and carrier compound precursor can be added simultaneously or sequentially in any order. The amount of sweetener carbohydrates and/or sweetener polyols used determines amount of carrier compound precursor added. The carrier compound precursor amount may be 0.001-4% or 0.01-4% weight/weight relative to a sum of total sweetener carbohydrate and sweetener polyol.

C) The reaction temperature may be optimized.

D) The conversion (e.g., conversion of carrier compound precursor to carrier compound) is monitored through pH measurements. The conversion does not have to be complete. The pH is monitored until reaching a desired level, which is chosen as the level allowing for greatest sweetness enhancement at the specific ratio of carrier to sweetener.

E) When the desired pH is obtained, further conversion by means of further addition of co-reagent or acid is stopped and the sweetener composition is obtained as a syrup. As an example, in the case that carrier compound precursor is converted to a carrier compound through an ion exchange process and ion exchange resin is used, the resin is removed from the system, for instance, by means of filtration.

F) Alternatively, in some cases, initial starting solutions are characterized by an acidic pH level. As an example, several fruit concentrates are characterized by acidic pH levels (e.g., apple juice may range in pH from 3.35 to 4; cranberry juice may range in pH from 2.3 to 2.52; grape juice may range in pH from 2.92 to 3.53; orange juice may range in pH from 3.3 to 4.19; lemon juice may range in pH from 2.00 to 2.60; lime juice may range in pH from 2.00 to 2.35; and tomato juice may range in pH from 4.10 to 4.60). When using such starting materials, conversion of carrier compound precursor to carrier compound may occur upon carrier compound precursor addition, even without the addition of a co-reagent or acid.

G) The sweetener composition is optionally dried. A sweetener composition powder may be obtained.

### Example 2: Formation of a Sweetener Composition

A starting solution is prepared with 65% sweetener carbohydrates and/or sweetener polyols and 35% solvent (e.g., deionized water) weight/weight. Carrier compound precursor is added to the solution of sweetener carbohydrates and/or sweetener polyols. The carrier compound precursor used is sodium silicate solution (Sigma Aldrich, 26.5% SiO₂, 10.6% Na₂O, weight/weight). The amount of carrier compound precursor is chosen to obtain a final carrier compound content of 0.4% weight/weight relative to sweetener carbohydrates and/or sweetener polyols. The solution is stirred for several minutes at 40° C. At this temperature, 1.5 equivalences of ion exchange resin relative to the carrier compound precursor are added. The resin converts the carrier compound precursor to a carrier compound. Interactions between the carrier compound and the sweetener carbohydrates and/or sweetener polyols form the sweetener composition. The pH level is decreased and the pH is monitored. After obtaining a desired pH of 8.5, the solution is filtered over a Buchner funnel to remove the resin.

### Example 3: Formation of a Mannose Sweetener Composition Using Different Percentages of Silicate and Ion Exchange Resin

65% mannose solution is prepared by dissolving mannose in water. Sodium silicate solution is added to the mannose solution in appropriate amounts to obtain desired silica percentage. 1.5 equivalents of Dowex 88(H) resin are added at once, and the pH is monitored until reaching a desired pH level. Samples are prepared with or without sonication during ion exchange at 40° C. Homogenization may occur prior to sonication, instead of sonication, or as a final stage.

| | | Distilled | | |
|---|---|---|---|---|
| | | deionized | Sodium | |
| | mannose | water | silicate | DOWEX 88(H) |
| Description | [g ± 0.1 mg] | [g ± 0.1 mg] | [μL ± 1 μL] | [g ± 0.1 mg] |
| 0.1% silica | 32.5 | 17.5 | 90 | 0.36 |
| 0.2% silica | 32.5 | 17.5 | 185 | 0.72 |
| 0.4% silica | 32.5 | 17.2 | 345 | 1.4 |
| 0.5% silica | 32.5 | 17.15 | 445 | 1.8 |
| 1% silica | 32.5 | 16.75 | 890 | 3.6 |

Sweetener composition is tasted against 65% mannose solution. For example, 50 of sweetener composition are tasted against 50 μL of 65% mannose solution. Sweetener composition may also be diluted, as an example to 10.6% mannose content, and tasted against 10.6% mannose solution.

A small sample is dried using an air blower at 70° C. If needed, sample is placed in oven to remove excess moisture. Then, dried sample is tasted in comparison to mannose. Each of mannose and dried sweetener composition is tasted as 10 mg.

### Example 4: Formation of an Allulose Sweetener Composition Using Different Percentages of Silicate and Ion Exchange Resin

65% allulose solution is prepared by dissolving allulose in water. Sodium silicate solution is added to the allulose solution in appropriate amounts to obtain desired silica percentage. 1.5 equivalents of Dowex 88(H) resin are added at once, and the pH is monitored until reaching a desired pH of 5-7. Samples are prepared with or without sonication during ion exchange at 40° C. Homogenization may occur prior to sonication, instead of sonication, or as a final stage.

| | | Distilled | | |
|---|---|---|---|---|
| | | deionized | Sodium | |
| | allulose | water | silicate | DOWEX 88(H) |
| Description | [g ± 0.1 mg] | [g ± 0.1 mg] | [μL ± 1 μL] | [g ± 0.1 mg] |
| 0.1% silica | 32.5 | 17.5 | 90 | 0.36 |
| 0.2% silica | 32.5 | 17.5 | 185 | 0.72 |
| 0.4% silica | 32.5 | 17.2 | 345 | 1.4 |
| 0.5% silica | 32.5 | 17.15 | 445 | 1.8 |
| 1% silica | 32.5 | 16.75 | 890 | 3.6 |

Sweetener composition is tasted against 65% allulose solution. For example, 50 μL of sweetener composition are tasted against 50 μL of 65% allulose solution. Sweetener composition may also be diluted, as an example to 10.6% allulose content, and tasted against 10.6% allulose solution.

A small sample is dried using an air blower at 70° C. If needed, sample is placed in oven to remove excess moisture. Then, dried sample is tasted in comparison to allulose. Each of allulose and dried sweetener composition is tasted as 10 mg.

### Example 5: Formation of a Tagatose Sweetener Composition Using Different Percentages of Silicate and Ion Exchange Resin

65% tagatose solution is prepared by dissolving tagatose in water. Sodium silicate solution is added to the tagatose solution in appropriate amounts to obtain desired silica percentage. 1.5 equivalents of Dowex 88(H) resin are added at once, and the pH is monitored until reaching a desired pH level. Samples are prepared with or without sonication during ion exchange at 40° C. Homogenization may occur prior to sonication, instead of sonication, or as a final stage.

| | | Distilled | | |
|---|---|---|---|---|
| | | deionized | Sodium | |
| | tagatose | water | silicate | DOWEX 88(H) |
| Description | [g ± 0.1 mg] | [g ± 0.1 mg] | [μL ± 1 μL] | [g ± 0.1 mg] |
| 0.1% silica | 32.5 | 17.5 | 90 | 0.36 |
| 0.2% silica | 32.5 | 17.5 | 185 | 0.72 |
| 0.4% silica | 32.5 | 17.2 | 345 | 1.4 |
| 0.5% silica | 32.5 | 17.15 | 445 | 1.8 |
| 1% silica | 32.5 | 16.75 | 890 | 3.6 |

Sweetener composition is tasted against 65% tagatose solution. For example, 50 μL of sweetener composition are tasted against 50 μL of 65% tagatose solution. Sweetener composition may also be diluted, as an example to 10.6% tagatose content, and tasted against 10.6% tagatose solution.

A small sample is dried using an air blower at 70° C. If needed, sample is placed in oven to remove excess moisture. Then, dried sample is tasted in comparison to tagatose. Each of tagatose and dried sweetener composition is tasted as 10 mg.

### Example 6: Formation of a Xylose Sweetener Composition Using Different Percentages of Silicate and Ion Exchange Resin

50% xylose solution is prepared by dissolving xylose in water. Sodium silicate solution is added to the xylose solution in appropriate amounts to obtain desired silica percentage. 1.5 equivalents of Dowex 88(H) resin are added at once, and the pH is monitored until reaching a desired pH level. Samples are prepared with or without sonication during ion exchange at 40° C. Homogenization may occur prior to sonication, instead of sonication, or as a final stage.

Sweetener composition is tasted against 50% xylose solution. For example, 50 μL of sweetener composition are tasted against 50 μL of 50% xylose solution. Sweetener composition may also be diluted, as an example to 10.6% xylose content, and tasted against 10.6% xylose solution.

A small sample is dried using an air blower at 70° C. If needed, sample is placed in oven to remove excess moisture. Then, dried sample is tasted in comparison to xylose. Each of xylose and dried sweetener composition is tasted as 10 mg.

### Example 7: Formation of a Galactose Sweetener Composition Using Different Percentages of Silicate and Ion Exchange Resin

65% galactose solution is prepared by dissolving galactose in water. Sodium silicate solution is added to the galactose solution in appropriate amounts to obtain desired silica percentage. 1.5 equivalents of Dowex 88(H) resin are added at once, and the pH is monitored until reaching a desired pH level. Samples are prepared with or without sonication during ion exchange at 40° C. Homogenization may occur prior to sonication, instead of sonication, or as a final stage.

| | | Distilled | | |
|---|---|---|---|---|
| | | deionized | Sodium | |
| | galactose | water | silicate | DOWEX 88(H) |
| Description | [g ± 0.1 mg] | [g ± 0.1 mg] | [μL ± 1 μL] | [g ± 0.1 mg] |
| 0.1% silica | 32.5 | 17.5 | 90 | 0.36 |
| 0.2% silica | 32.5 | 17.5 | 185 | 0.72 |
| 0.4% silica | 32.5 | 17.2 | 345 | 1.4 |
| 0.5% silica | 32.5 | 17.15 | 445 | 1.8 |
| 1% silica | 32.5 | 16.75 | 890 | 3.6 |

Sweetener composition is tasted against 65% galactose solution. For example, 50 μL of sweetener composition are tasted against 50 μL of 65% galactose solution. Sweetener composition may also be diluted, as an example to 10.6% galactose content, and tasted against 10.6% galactose solution.

A small sample is dried using an air blower at 70° C. If needed, sample is placed in oven to remove excess moisture. Then, dried sample is tasted in comparison to galactose. Each of galactose and dried sweetener composition is tasted as 10 mg.

### Example 8: Formation of an Arabinose Sweetener Composition Using Different Percentages of Silicate and Ion Exchange Resin

65% arabinose solution is prepared by dissolving arabinose in water. Sodium silicate solution is added to the arabinose solution in appropriate amounts to obtain desired silica percentage. 1.5 equivalents of Dowex 88(H) resin are added at once, and the pH is monitored until reaching a desired pH level. Samples are prepared with or without sonication during ion exchange at 40° C. Homogenization may occur prior to sonication, instead of sonication, or as a final stage.

| | | Distilled | | |
|---|---|---|---|---|
| | | deionized | Sodium | |
| | arabinose | water | silicate | DOWEX 88(H) |
| Description | [g ± 0.1 mg] | [g ± 0.1 mg] | [μL ± 1 μL] | [g ± 0.1 mg] |
| 0.1% silica | 32.5 | 17.5 | 90 | 0.36 |
| 0.2% silica | 32.5 | 17.5 | 185 | 0.72 |
| 0.4% silica | 32.5 | 17.2 | 345 | 1.4 |
| 0.5% silica | 32.5 | 17.15 | 445 | 1.8 |
| 1% silica | 32.5 | 16.75 | 890 | 3.6 |

Sweetener composition is tasted against 65% arabinose solution. For example, 50 μL of sweetener composition are tasted against 50 μL of 65% arabinose solution. Sweetener composition may also be diluted, as an example to 10.6% arabinose content, and tasted against 10.6% arabinose solution.

A small sample is dried using an air blower at 70° C. If needed, sample is placed in oven to remove excess moisture. Then, dried sample is tasted in comparison to arabinose. Each of arabinose and dried sweetener composition is tasted as 10 mg.

### Example 9: Formation of a Sucrose Sweetener Composition Using Different Percentages of Silicate and Ion Exchange Resin

65% sucrose solution is prepared by dissolving sucrose in water. Sodium silicate solution is added to the sucrose solution in appropriate amounts to obtain desired silica percentage. 1.5 equivalents of Dowex 88(H) resin are added at once, and the pH is monitored until reaching a desired pH of 7.0-8.5. Samples are prepared with or without sonication during ion exchange at 40° C. Homogenization may occur prior to sonication, instead of sonication, or as a final stage.

| | | Distilled | | |
|---|---|---|---|---|
| | | deionized | Sodium | |
| | sucrose | water | silicate | DOWEX 88(H) |
| Description | [g ± 0.1 mg] | [g ± 0.1 mg] | [μL ± 1 μL] | [g ± 0.1 mg] |
| 0.1% silica | 32.5 | 17.5 | 90 | 0.36 |
| 0.2% silica | 32.5 | 17.5 | 185 | 0.72 |
| 0.4% silica | 32.5 | 17.2 | 345 | 1.4 |
| 0.5% silica | 32.5 | 17.15 | 445 | 1.8 |
| 1% silica | 32.5 | 16.75 | 890 | 3.6 |

Sweetener composition is tasted against 65% sucrose solution. For example, 50 μL of sweetener composition are tasted against 50 μL of 65% sucrose solution. Sweetener composition may also be diluted, as an example to 10.6% sucrose content, and tasted against 10.6% sucrose solution.

A small sample is dried using an air blower at 70° C. If needed, sample is placed in oven to remove excess moisture. Then, dried sample is tasted in comparison to sucrose. Each of sucrose and dried sweetener composition is tasted as 10 mg.

### Example 10: Formation of a Sucrose Sweetener Composition

Preparation of a sweetener composition can be scaled up by increasing the amounts used.

| | | Distilled | | |
|---|---|---|---|---|
| | | deionized | Sodium | |
| | sucrose | water | silicate | DOWEX 88(H) |
| Description | [g ± 0.1 mg] | [g ± 0.1 mg] | [g ± 0.1 mg] | [g ± 0.1 mg] |
| 0.4% silica | 390.0076 | 206.4106 | 5.8882 | 17.2864 |

Sweetener composition is tasted against 65% sucrose solution. For example, 50 μL of sweetener composition are tasted against 50 μL of 65% sucrose solution. Sweetener composition may also be diluted, as an example to 10.6% sucrose content, and tasted against 10.6% sucrose solution.

| | | | | Sweetener |
|---|---|---|---|---|
| | | Sweetener | | composition |
| | | composition | | with 0.4% silica, |
| | 65% | with | 10.6% | diluted to |
| | sucrose | 0.4% silica | sucrose | 10.6% sucrose |
| Taster 1 | X | X + 0.25 | Y | Y + 0.5 |
| Taster 2 | X | X + 0.25 | Y | Y + 0.5 |
| Taster 3 | X | X + 0.5 | Y | Y + 0.5 |
| Total | 0 | X + 0.33 | 0 | Y + 0.5 |

Key: X represents a level of sweetness, X + 0.25 represents a taste that is sweeter than X, X + 0.33 represents a taste that is sweeter than X + 0.25, X + 0.5 represents a taste that is sweeter than X + 0.33.
Y represents a level of sweetness, Y + 0.5 represents a taste that is sweeter than Y.

### Example 11: Formation of a Mannose Sweetener Composition Using Silicate and Citric Acid

65% mannose solution is prepared. Sodium silicate solution is added in appropriate amounts to obtain desired silica percentage of 0.2%. Citric acid is added portion-wise and the pH decrease is monitored, until reaching a desired value. Samples are prepared at room temperature.

Sweetener composition is tasted against 65% mannose solution. For example, 50 μL of sweetener composition are tasted against 50 μL of 65% mannose solution. Sweetener composition may also be diluted, as an example to 10.6% mannose content, and tasted against 10.6% mannose solution.

A small sample is dried using an air blower at 70° C. If needed, sample is placed in oven to remove excess moisture. Then, dried sample is tasted in comparison to mannose. Each of mannose and dried sweetener composition is tasted as 10 mg.

### Example 12: Formation of an Allulose Sweetener Composition Using Silicate and Citric Acid

65% allulose solution is prepared. Sodium silicate solution is added in appropriate amounts to obtain desired silica percentage of 0.2%. Citric acid is added portion-wise and the pH decrease is monitored, until reaching a desired value. Samples are prepared at room temperature.

Sweetener composition is tasted against 65% allulose solution. For example, 50 μL of sweetener composition are tasted against 50 μL of 65% allulose solution. Sweetener composition may also be diluted, as an example to 10.6% allulose content, and tasted against 10.6% allulose solution.

A small sample is dried using an air blower at 70° C. If needed, sample is placed in oven to remove excess moisture. Then, dried sample is tasted in comparison to allulose. Each of allulose and dried sweetener composition is tasted as 10 mg.

### Example 13: Formation of a Tagatose Sweetener Composition Using Silicate and Citric Acid

65% tagatose solution is prepared. Sodium silicate solution is added in appropriate amounts to obtain desired silica percentage of 0.2%. Citric acid is added portion-wise and the pH decrease is monitored, until reaching a desired value. Samples are prepared at room temperature.

Sweetener composition is tasted against 65% tagatose solution. For example, 50 μL of sweetener composition are tasted against 50 μL of 65% tagatose solution. Sweetener composition may also be diluted, as an example to 10.6% tagatose content, and tasted against 10.6% tagatose solution.

A small sample is dried using an air blower at 70° C. If needed, sample is placed in oven to remove excess moisture. Then, dried sample is tasted in comparison to tagatose. Each of tagatose and dried sweetener composition is tasted as 10 mg.

### Example 14: Formation of a Xylose Sweetener Composition Using Silicate and Citric Acid

50% xylose solution is prepared. Sodium silicate solution is added in appropriate amounts to obtain desired silica percentage of 0.2%. Citric acid is added portion-wise and the pH decrease is monitored, until reaching a desired value. Samples are prepared at room temperature.

Sweetener composition is tasted against 50% xylose solution. For example, 50 μL of sweetener composition are tasted against 50 μL of 50% xylose solution. Sweetener composition may also be diluted, as an example to 10.6% xylose content, and tasted against 10.6% xylose solution.

A small sample is dried using an air blower at 70° C. If needed, sample is placed in oven to remove excess moisture. Then, dried sample is tasted in comparison to xylose. Each of xylose and dried sweetener composition is tasted as 10 mg.

### Example 15: Formation of a Galactose Sweetener Composition Using Silicate and Citric Acid

65% galactose solution is prepared. Sodium silicate solution is added in appropriate amounts to obtain desired silica percentage of 0.2%. Citric acid is added portion-wise and the pH decrease is monitored, until reaching a desired value. Samples are prepared at room temperature.

Sweetener composition is tasted against 65% galactose solution. For example, 50 μL of sweetener composition are tasted against 50 μL of 65% galactose solution. Sweetener composition may also be diluted, as an example to 10.6% galactose content, and tasted against 10.6% galactose solution.

A small sample is dried using an air blower at 70° C. If needed, sample is placed in oven to remove excess moisture. Then, dried sample is tasted in comparison to galactose. Each of galactose and dried sweetener composition is tasted as 10 mg.

### Example 16: Formation of an Arabinose Sweetener Composition Using Silicate and Citric Acid

65% arabinose solution is prepared. Sodium silicate solution is added in appropriate amounts to obtain desired silica percentage of 0.2%. Citric acid is added portion-wise and the pH decrease is monitored, until reaching a desired value. Samples are prepared at room temperature.

Sweetener composition is tasted against 65% arabinose solution. For example, 50 μL of sweetener composition are tasted against 50 μL of 65% arabinose solution. Sweetener composition may also be diluted, as an example to 10.6% arabinose content, and tasted against 10.6% arabinose solution.

A small sample is dried using an air blower at 70° C. If needed, sample is placed in oven to remove excess moisture. Then, dried sample is tasted in comparison to arabinose. Each of arabinose and dried sweetener composition is tasted as 10 mg.

### Example 17: Formation of a Sucrose Sweetener Composition Using Silicate and Citric Acid

65% sucrose solution is prepared. Sodium silicate solution is added in appropriate amounts to obtain desired silica percentage of 0.2%. Citric acid is added portion-wise and the pH decrease is monitored, until reaching a desired value of about 8.5. Samples are prepared at room temperature.

| Equivalences of citric | |
|---|---|
| acid relative to sodium ions | pH level |
| 0 | 9.86 |
| 0.233 | 9.82 |
| 0.466 | 9.72 |
| 0.699 | 9.4 |
| 0.908 | 8.75 |
| 0.955 | 8.67 |

Sweetener composition is tasted against 65% sucrose solution. For example, 50 μL of sweetener composition are tasted against 50 μL of 65% sucrose solution. Sweetener composition may also be diluted, as an example to 10.6% sucrose content, and tasted against 10.6% sucrose solution.

A small sample is dried using an air blower at 70° C. If needed, sample is placed in oven to remove excess moisture. Then, dried sample is tasted in comparison to sucrose. Each of sucrose and dried sweetener composition is tasted as 10 mg.

### Example 18: Dried Sweetener Composition Taste Testing

65% sucrose solution is prepared. Sodium silicate solution is added in appropriate amounts to obtain desired silica percentage of 0.4% relative to sucrose (w/w). 1.5 equivalents of Dowex 88(H) resin are added. Samples are prepared at 40° C. Final pH of about 8.5 is obtained. A small sample is dried using an air blower at 70° C. If needed, sample is placed in oven to remove excess moisture. Then, dried sample is tasted in comparison to sucrose. Each of sucrose and dried sweetener composition is tasted as 10 mg.

| | | Dried 65% sucrose, |
|---|---|---|
| | Sucrose | 0.4% silica |
| Taster 1 | X | X + 0.5 |
| Taster 2 | X | X + 1 |
| Taster 3 | X | X + 1.25 |
| Average | X | X + 0.92 |

Key: X represents a level of sweetness, X + 0.5 represents a taste that is more sweet than X, X + 1 represents a taste that is more sweet than X + 0.5, X + 1.25 represents a taste that is more sweet than X + l.

### Example 19: Sensory Test Procedure

A panel of 8 sensory-tested and trained tasting experts participate in the sensory test. The tests are divided into the following 4 segments:
a) Testing the sensory threshold of the tasters
b) Calibration
c) Control composition versus sweetener composition tastings—in powder and syrup form
d) Control composition versus sweetener composition tastings—powders mixed in a separate medium

Tasting process: Tasting stages, excluding calibration, are conducted in the form of a “triangle test”: each participant is given three samples marked with random numbers that include two identical samples and one dissimilar sample. Participants are instructed to name the different sample in each set and explain the difference in their opinion.

Participants are given two sets of tests in each tasting, where one test includes a single reference sample and the other test contains two reference samples.

Sensory threshold: Panel participants are given seven triangle tests that include various concentrations of control composition (e.g., sucrose) dissolved in water.

Calibration step: This step is another form of testing the panel's sensory threshold for sweetness. Panel members are given two samples of control composition (e.g., sucrose) marked “A” and “B” of different concentrations or amounts (e.g., samples of 4 mg and 5 mg) to test the panel's ability to recognize variations.

The remaining tests are conducted similarly—each sample is tested with control composition (e.g., sucrose) as a reference in two sets of triangle tests.

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention. It is intended that the following claims define the scope of the invention and that methods and structures within the scope of these claims and their equivalents be covered thereby.

What is claimed is:

1. A method of producing a sweetener composition, comprising mixing one or more sweetener carbohydrates and/or sweetener polyols with a carrier compound precursor and a co-reagent or acid to produce a sweetener composition; wherein the sweetener composition comprises one or more sweetener carbohydrates and/or sweetener polyols and about 0.001-4% carrier compound weight/weight relative to a sum of total sweetener carbohydrate and sweetener polyol; the carrier compound is silica; the sweetener composition has enhanced sweetness compared to a control composition; and the control composition consists of the same contents by identity and quantity as the one or more sweetener carbohydrates and/or sweetener polyols.

2. The method of claim 1, wherein the carrier compound precursor is a silicate.

3. The method of claim 2, wherein the silicate is sodium silicate, potassium silicate, calcium silicate, aluminum silicate, tetramethylammonium silicate, sodium metasilicate, sodium metasilicate hydrate, calcium metasilicate, or any combination thereof.

4. The method of claim 1, wherein the carrier compound precursor is silicic acid.

5. The method of any one of claims 1-4, wherein the co-reagent or acid is an acid, ion exchange resin, ion exchange polymer, or any combination thereof.

6. The method of claim 5, wherein the acid is acetic acid, aconitic acid, adipic acid, alginic acid, ascorbic acid, benzoic acid, caprylic acid, carbonic acid, citric acid, fumaric acid, hydrochloric acid, lactic acid, linoleic acid, malic acid, phosphoric acid, propionic acid, quinic acid, salicylic acid, sorbic acid, stearic acid, succinic acid, sulfuric acid, tannic acid, tartaric acid, vinegar, a dairy product, milk, condensed milk, cream, buttermilk, yogurt, fruit juice, fruit juice concentrate, nectar, vegetable juice, or any combination thereof.

7. The method of any one of claims 1-6, further comprising homogenizing the sweetener composition, one or more sweetener carbohydrates and/or sweetener polyols, carrier compound, carrier compound precursor, or co-reagent or acid.

8. The method of claim 7, further comprising cooling or heating prior to homogenizing.

9. The method of any one of claims 1-6, further comprising sonicating the sweetener composition, one or more sweetener carbohydrates and/or sweetener polyols, carrier compound, carrier compound precursor, or co-reagent or acid.

10. The method of claim 9, further comprising cooling or heating prior to sonicating.

11. The method of claim 9, wherein the sonicating is performed using a bath sonicator or a probe sonicator.

12. The method of any one of claims 1-6, further comprising dispersing the sweetener composition, one or more sweetener carbohydrates and/or sweetener polyols, carrier compound, carrier compound precursor, or co-reagent or acid.

13. The method of any one of claims 1-12, further comprising passing the sweetener composition through a sieve or sieving tower.

14. The method of any one of claims 1-13, further comprising drying the sweetener composition.

15. The method of any one of claims 1-14, wherein the sweetener composition comprises a dairy product, fruit juice, fruit juice concentrate, nectar, or vegetable juice.

16. The method of any one of claims 1-14, wherein the one or more sweetener carbohydrates and/or sweetener polyols comprise mannose, allulose, xylose, galactose, arabinose, galactofructose, or any combination thereof.

17. The method of any one of claims 1-14, wherein the one or more sweetener carbohydrates and/or sweetener polyols is tagatose.

18. The method of any one of claims 1-14, wherein the one or more sweetener carbohydrates are selected from the group consisting of sucrose, glucose, fructose, maltose, lactose, mannose, allulose, tagatose, xylose, galactose, arabinose, galactofructose, high fructose corn syrup, high maltose corn syrup, and any combination thereof.

19. The method of any one of claims 1-14, wherein the one or more sweetener polyols are selected from the group consisting of xylitol, maltitol, erythritol, sorbitol, threitol, arabitol, hydrogenated starch hydrolysates, isomalt, lactitol, mannitol, galactitol (dulcitol), and any combination thereof.

20. The method of any one of claims 1-19, wherein the sweetener composition includes about 0.01-4% carrier compound weight/weight relative to a sum of total sweetener carbohydrate and sweetener polyol.

21. The method of any one of claims 1-19, wherein the sweetener composition includes about 0.01-2% carrier compound weight/weight relative to a sum of total sweetener carbohydrate and sweetener polyol.

22. The method of any one of claims 1-19, wherein the sweetener composition includes about 0.01-0.5% carrier compound weight/weight relative to a sum of total sweetener carbohydrate and sweetener polyol.

23. A sweetener composition made according to the method of any one of claims 1-22.

24. The sweetener composition of claim 23, wherein the sweetener composition does not comprise an artificial sweetener or a natural sugar substitute.

25. The sweetener composition of any one of claims 23-24, wherein the sweetener composition comprises water.

26. The sweetener composition of claim 25, wherein the sweetener composition is in the form of a syrup.

27. The sweetener composition of claim 25, wherein the sweetener composition is in the form of particles.
